(19) United States
(12) Patent Application Publication
(10) Pub. No.: US 2024/0416531 A1
(43) Pub. Date: Dec. 19, 2024

(54) PACKING SYSTEMS AND METHODS, AND GRIPPERS FOR THE SAME

(71) Applicant: WestRock Packaging Systems, LLC, Atlanta, GA (US)

(72) Inventors: Frederic LIMOUSIN, Le Poinçonnet (FR); Stefano BERNINI, Villedieu sur indre (FR)

(21) Appl. No.: 18/701,417

(22) PCT Filed: Oct. 16, 2022
(86) PCT No.: PCT/US2022/046809

§ 371 Date: Apr. 15, 2024

Related U.S. Application Data
(60) Provisional application No. 63/256,145, filed on Oct. 15, 2021.

(51) Int. Cl. B25J 15/06; B65B 35/18; B65B 35/58

(52) U.S. Cl. CPC B25J 15/0683; B25J 15/0625; B65B 35/18; B65B 35/58

(57) ABSTRACT

A gripper for a packaging system includes a suction body forming a first vacuum cavity and a suction cup coupled to the suction body and forming a second vacuum cavity. The second vacuum cavity of the suction cup is in selective fluid communication with the first vacuum cavity of the suction body.

### FIELD

The present disclosure relates to packing systems and methods and, more particularly, to systems and methods for packing and orienting containers and container grippers for maintaining an orientation of a container through a packaging process.

### BACKGROUND

In the field of packaging, it is often desirable to provide a package including multiple primary product containers, such as multi-packs, for shipping and distribution and for display of promotional information. It is also often desirable to present the packaged containers, such as cans, in a particular orientation. It is also often required that the containers be free of defects, such as scratches, dents and smears. However, maintaining the containers in a desired orientation throughout the packaging process, while maintaining them in a blemish-free condition, can be challenging. While conventional packaging systems and method have generally been considered satisfactory for their intended purpose, there is still a need for improved container handling that maintains the desired orientation. Accordingly, those skilled in the art continue with research and development efforts in the field of container packaging.

### SUMMARY

Disclosed are a system for packaging containers, a gripper for maintaining a desired orientation of a container and a method for packaging containers. The following is a non-exhaustive list of examples, which may or may not be claimed, of the subject matter according to the present disclosure.

In an example, the disclosed gripper includes a suction body forming a first vacuum cavity and a suction cup coupled to the suction body and forming a second vacuum cavity. The second vacuum cavity of the suction cup is in selective fluid communication with the first vacuum cavity of the suction body.

In an example, the disclosed system includes a track and a gripper movable along the track. The gripper is configured to be releasably coupled to a container via vacuum to guide the container along a portion of the track and to maintain the container in a desired orientation.

In an example, the disclosed packaging method includes steps of: (1) orienting a container in a desired orientation; (2) transferring the container to a gripper as the gripper moves along a track; (3) coupling the container to the gripper via vacuum; (4) guiding the container along a portion of the track using the gripper; (5) maintaining the desired orientation of the container using the gripper; and (6) releasing the container from the gripper.

Other examples of the disclosed system, gripper and method will become apparent from the following detailed description, the accompanying drawings, and the appended claims.

### BRIEF DESCRIPTION OF THE DRAWINGS

FIG. 1 is a schematic, perspective view of an example of a portion of a system for packaging containers;

FIG. 2 is a schematic, top plan view of an example of a portion of the system;

FIG. 3 is a schematic, top plan view of an example of a portion of the system;

FIG. 4 is a schematic, top plan view of an example of a portion of the system;

FIG. 5 is a schematic, top plan view of an example of a portion of the system;

FIG. 6 is a schematic, top plan view of an example of a portion of the system;

FIG. 7 is a schematic, top plan view of an example of a portion of the system;

FIG. 7A is a schematic illustration of an example of a portion of a metering screw of the system;

FIG. 7B is a schematic illustration of an example of a portion of a star-wheel of the system;

FIG. 7C is a schematic illustration of an example of a portion of the star-wheel of the system;

FIG. 8 is a schematic, top plan view of an example of a portion of the system;

FIG. 8A is a schematic illustration of an example of a portion of the metering screw of the system;

FIG. 8B is a schematic illustration of an example of a portion of the star-wheel of the system;

FIG. 8C is a schematic illustration of an example of a portion of the star-wheel of the system;

FIG. 9 is a schematic, top plan view of an example of a portion of the system;

FIG. 9A is a schematic illustration of an example of a portion of the metering screw of the system;

FIG. 9B is a schematic illustration of an example of a portion of the star-wheel of the system;

FIG. 9C is a schematic illustration of an example of a portion of the star-wheel of the system;

FIG. 10 is a schematic, perspective view of an example of an orienting module of the system;

FIG. 11 is a schematic, perspective view of an example of a portion of the orienting module;

FIG. 12 is a schematic, top plan view of an example of a grouping module of the system;

FIG. 13A is a schematic, top plan view of an example of a portion of the grouping module;

FIG. 13A is a graphical representation of an example of a velocity profile for lugs and grippers of the grouping module;

FIG. 14 is a schematic, perspective view of an example of a portion of the system;

FIG. 15 is a schematic, perspective view of an example of a portion of the system;

FIG. 16 is a schematic, perspective view of an example of a gripper of the system;

FIG. 17 is a schematic, perspective view of an example of a portion of the system;

FIG. 18 is a schematic, perspective view of an example of a portion of the system;

FIG. 19 is a schematic, top plan view of an example of a portion of the system;

FIG. 20 is a schematic illustration of an example of the gripper of the system;

FIG. 21 is a graphical representation of an example of centrifugal force acting on a container moving along a track of the grouping module;

FIG. 22A is a schematic illustration of an example of a portion of the system;

FIG. 22B is a graphical representation of an example of vacuum pressure acting on a container moving along the track of the grouping module;

FIG. 23A is a schematic, perspective view of an example of the gripper;

FIG. 23B is a schematic, perspective view of a portion of gripper shown in FIG. 23A;

FIG. 23C is a schematic, perspective, partially exploded view of the gripper shown in FIG. 23A;

FIG. 24A is a schematic, perspective, sectional view of an example of the gripper;

FIG. 24B is a schematic, perspective, section view of an example of the gripper;

FIG. 25A is a schematic, perspective, sectional view of an example of a portion of the gripper;

FIG. 25B is a schematic, perspective, section view of an example of a portion of the gripper;

FIG. 26A is a schematic, perspective, section view of an example of a portion of the gripper;

FIG. 26B is a schematic, perspective, section view of an example of a portion of the gripper; and

FIG. 27A is a schematic illustration of an example of a portion of the system;

FIG. 27B is a graphical representation of an example of vacuum pressure acting on a container moving along the track of the grouping module;

FIG. 28A is a schematic, elevation, sectional view of an example of the gripper;

FIG. 28B is a schematic, perspective view of an example of a portion of the gripper;

FIG. 28C is a schematic, elevation, sectional view of an example of a portion of the gripper;

FIG. 29 is a schematic, perspective view of an example of a portion of the gripper; and

FIG. 30 is a flow diagram of an example of a method for packaging containers.

### DETAILED DESCRIPTION

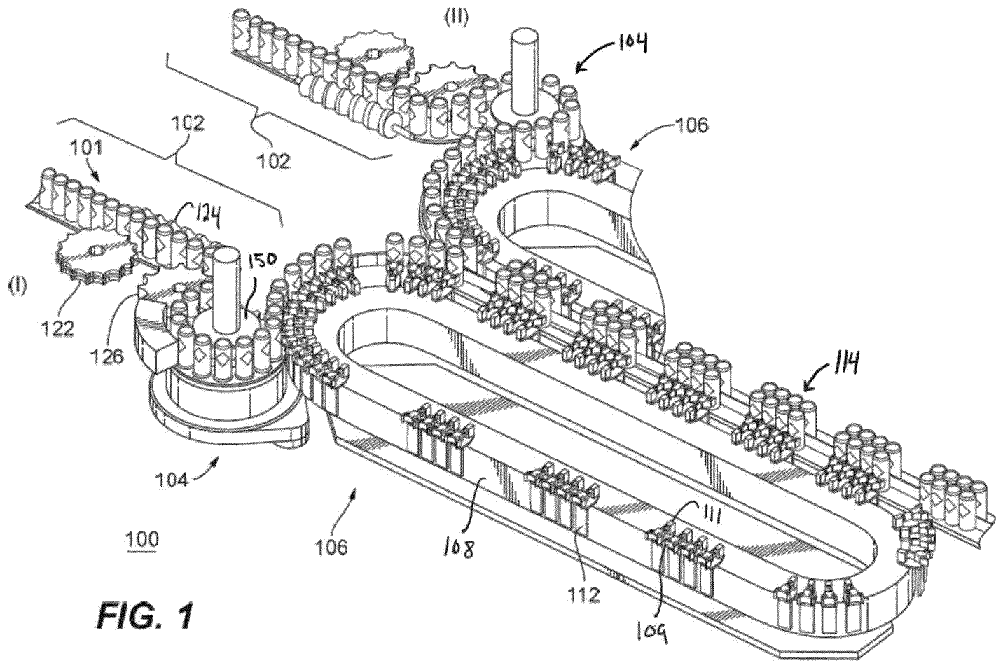

Referring generally to FIGS. 1-30, by way of examples, the present disclosure is directed to system 100 for packaging containers 101 (herein below referred to collectively as containers and individually as container) and grippers of system 100 for holding containers 101 in a desired orientation. More particularly, examples of system 100 enable packing and orienting containers 101 for creating packages of containers 101. More particularly, examples of system 100 facilitate metering of a stream of containers 101, orienting each one of containers 101 is a desired orientation and maintaining the desired orientation throughout a packaging process.

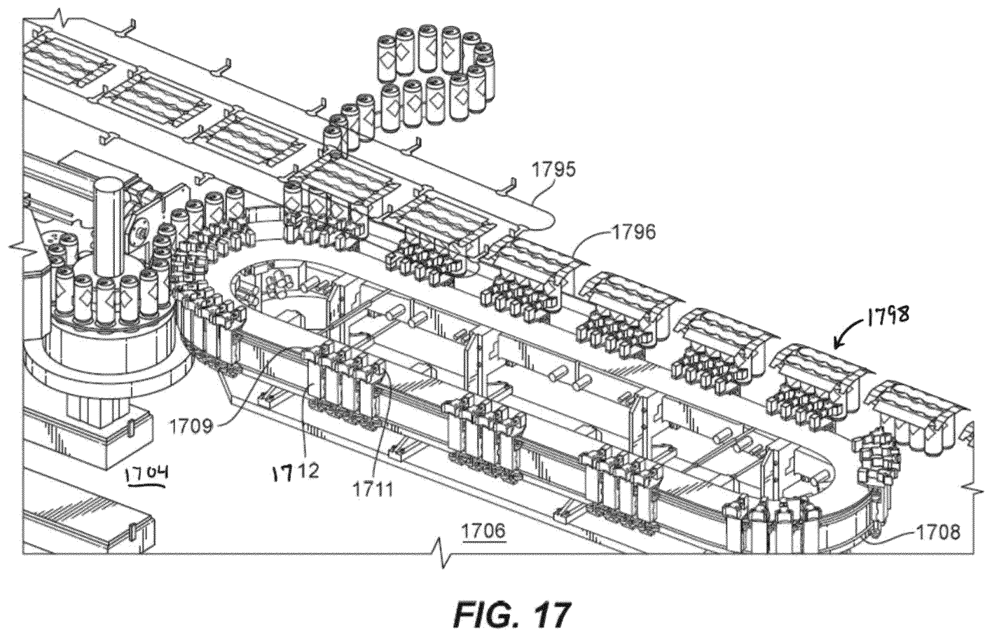

Referring now to FIG. 1, which illustrates an example of a portion of system 100. Generally, as illustrated in FIG. 1, system 100 is configured to receive a stream of containers 101, to orient each one of containers 101 into a desired direction and/or orientation and to maintain each one of containers 101 in the desired direction and/or orientation while packaging containers 101 into packs 114 (e.g., as shown in FIG. 1) or other packages 1798 (e.g., as shown in FIG. 17).

In one or more examples, system 100 includes two sets of modules (e.g., a first module set I and a second module set II). In one or more examples, each set of modules is a mirror of the other. For example, each set of modules includes the same three types of modules. Each of the modules of the set of modules, the details and capabilities of each module and various example configurations of each module are described herein below.

In one or more examples, each set of modules (e.g., the first module set I and/or the second module set II) includes conveying module 102, orienting module 104 and grouping module 106. In one or more examples, conveying module 102 is configured for supplying containers 101, for example, as a stream of containers 101. In one or more examples, orienting module 104 is configured for scanning and orienting containers 101. In one or more examples, grouping module 106 is configured for organizing containers 101 in the desired orientation (e.g., oriented containers) into groups and/or packs 114.

In FIG. 1, conveying module 102, orienting module 104 and grouping module 106 of the first module set I are shown and labelled. In FIG. 1, conveying module 102, orienting module 104 and a portion of grouping module 106 of the second module set II are shown. Although two sets of modules (e.g., module set I and module set II) are shown in FIG. 1, each module in the subsequent figures and in the description below may be discussed as part of an individual set (e.g., module set I), not including its mirrored counterpart (e.g., module set II).

In one or more examples, conveying module 102 includes first star-wheel 122, metering screw 124 and second star-wheel 126. Orienting module 104 includes third star-wheel 150. Grouping module 106 includes track 108. Grouping module 106 includes lugs 111 (herein below referred to collectively as lugs and individually as lug). Lugs 111 are coupled to and movable along track 108. Grouping module 106 includes grippers 109 (herein below referred to collectively as grippers and individually as gripper). Grippers 109 are coupled to lugs 111 (e.g., each gripper 109 is coupled to an associated lug 111). Grouping module 106 includes servo drives 112 (herein below referred to collectively as servo drives and individually as servo drive). Lugs 111 are driven about track 108 by servo drives 112 (e.g., each lug 111 is driven by an associated servo drive 112).

System 100 offers multiple benefits over previous conveyor systems in a world that demands faster and more efficient production techniques. Examples of such benefits offered by system 100 includes, but are not limited to, faster and more convenient changeover between differing container sizes and types; faster, more reliable, and more effective methods of packaging containers into groups; and reducing factory floor space required for packaging.

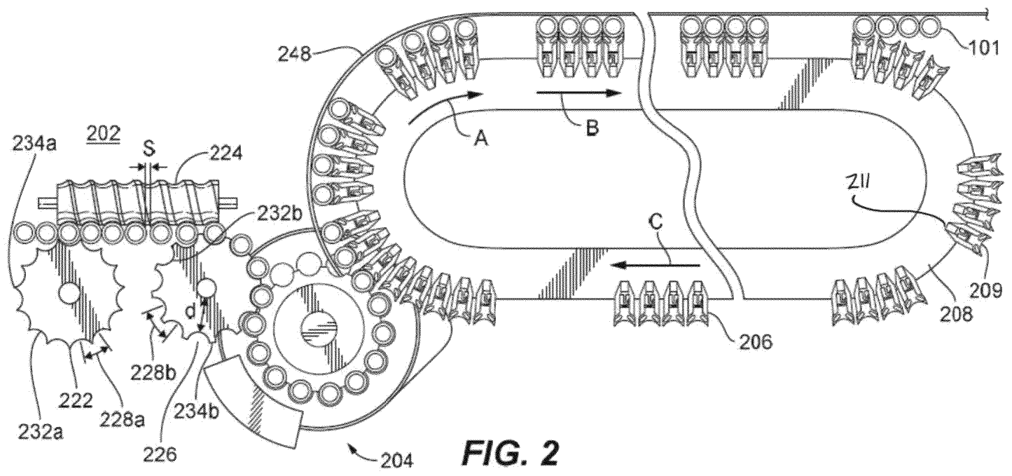

Referring now to FIG. 2, which illustrates an example of one of the sets of modules (e.g., module set I shown in FIG. 1) of system 100. The example of system 100 shown in FIG. 2 shares many common features with the example of system 100 shown in FIG. 1. In the example of system 100 shown in FIG. 2, like numerals have, where possible, been used to denote like parts, albeit with the addition of the prefix “200” to indicate that these features belong to a second example of system 100.

In one or more examples, the module set includes conveying module 202, orienting module 204, and grouping module 206. Grouping module 206 includes track 208. In one or more examples, track 208 is a single oval track.

In one or more examples, grouping module 206 includes a plurality of grippers 209 (herein below referred to collectively as grippers and individually as gripper). Grippers 209 move containers 101 along track 208.

In one or more examples, grouping module 206 includes a plurality of lugs 211 (herein below referred to collectively as lugs and individually as lug). Each gripper 209 is coupled to an associated lug 211. Lugs 211 move grippers 209 along track 208.

In one or more examples, grouping module 206 includes a plurality of servo drives (e.g., servo drives 112 as shown in FIG. 1). The servo drives of the example of system 100 shown in FIG. 2 are not visible. Each lug 211 is driven about track 208 by an associated servo drive (e.g., servo drive 112 as shown in FIG. 1).

Referring to FIGS. 1 and 2, in one or more examples, servo drive 112 is a linear servo drive. This allows for programming of a specific speed profile for each lug 111, 211 or group of lugs 111, 211, which can move separately from one another to form groups (e.g., packs 114 as shown in FIG. 1) of containers 101. Another added benefit of the horizontal oval configuration of track 108, 208 is, when power to system 100 is lost, lugs 111, 211 stay in place and are not moved by gravity and do not fall from track 108, 208.

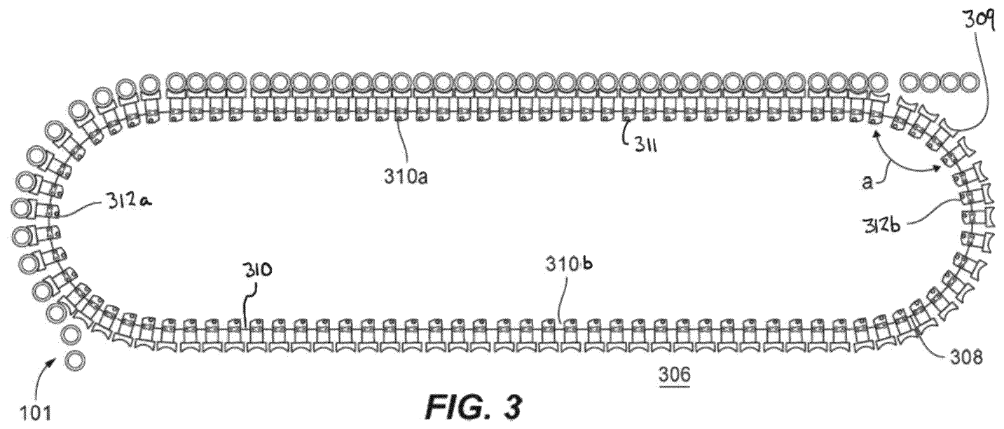

Referring now to FIG. 3, which illustrates an example of grouping module 306 of system 100. The example of system 100 shown in FIG. 3 shares many common features with the examples of system 100 shown in FIGS. 1 and 2. In the example of system 100 shown in FIG. 3, like numerals have, where possible, been used to denote like parts, albeit with the addition of the prefix “300” to indicate that these features belong to a third example of system 100.

In one or more examples, grouping module 306 includes track 308. Track 308 is a single oval track. Grippers 309 move containers 101 along track 308. Each gripper 309 is moved about track 308 by chain 310.

In one or more examples, track 308 of grouping module 406 is a single track 308 that includes two straight sections (e.g., first straight section 310a and second straight section 310b) and two curved sections (e.g., first curved section 312a and second curved section 312b).

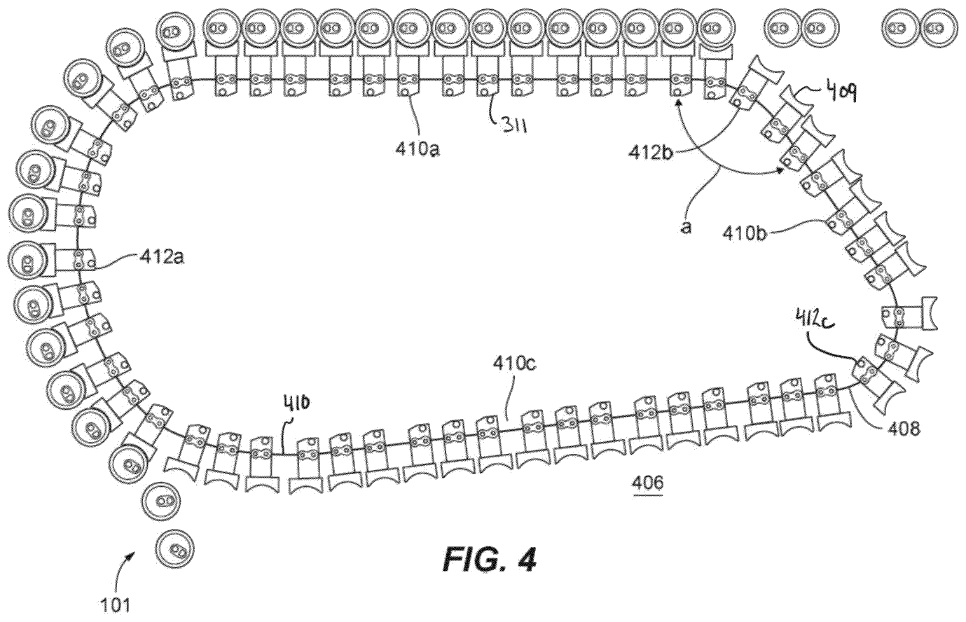

Referring now to FIG. 4, which illustrates an example of grouping module 406 of system 100. The example of system 100 shown in FIG. 4 shares many common features with the examples of system 100 shown in FIGS. 1-3. In the example of system 100 shown in FIG. 4, like numerals have, where possible, been used to denote like parts, albeit with the addition of the prefix “400” to indicate that these features belong to a fourth example of system 100.

In one or more examples, grouping module 406 includes track 408. Track 408 is a single irregular-shaped track. Grippers 409 move containers 101 along track 408. Each gripper 409 is moved about track 408 by chain 410.

In one or more examples, track 408 of grouping module 406 is a single track that includes three (e.g., at least three) straight sections 410a, 410b, 410c and three (e.g., at least two) curved sections 412a, 412b, 412c.

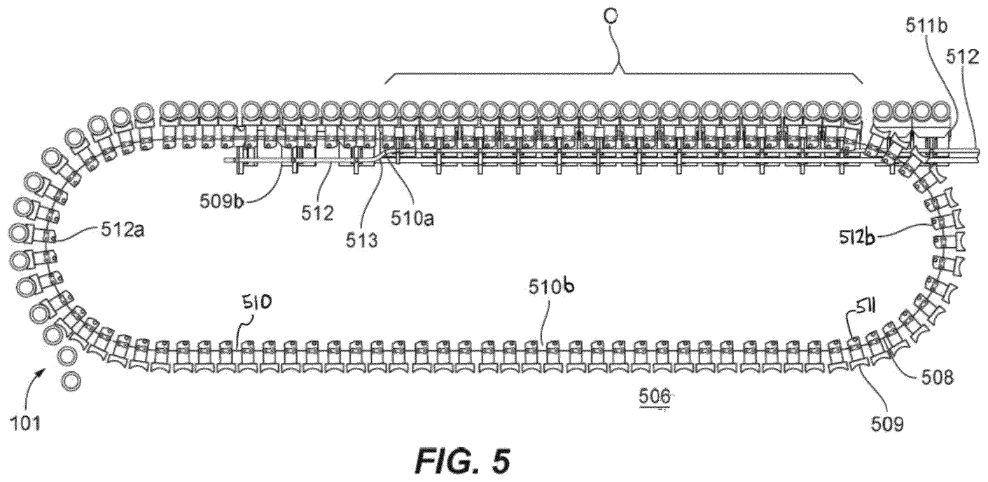

Referring now to FIG. 5, which illustrates an example of grouping module 506 of system 100. The example of system 100 shown in FIG. 5 shares many common features with the examples of system 100 shown in FIGS. 1-4. In the example of system 100 shown in FIG. 5, like numerals have, where possible, been used to denote like parts, albeit with the addition of the prefix “500” to indicate that these features belong to a fifth example of system 100.

In one or more examples, grouping module 506 includes track 508. Track 408 is a single oval track. Grippers 509 move containers 101 along track 508. Each gripper 509 is moved about track 508 by chain 510.

In one or more examples, track 508 of grouping module 506 is a single oval track that includes two straight sections 510a and 510b and two curved sections 512a, 512b.

In one or more examples, grouping module 506 also includes second track 512. Second track 512 is disposed in a vertical plane that takes the container hand-off from track 508 (also referred to as first track). Second track 512 uses a second set or second plurality of second grippers 509b (herein referred to collectively as second grippers and individually as second gripper) and second set or second plurality of second lugs 511b (herein referred to collectively as second lugs and individually as second lug) to transport containers 101 after receiving them from track 508.

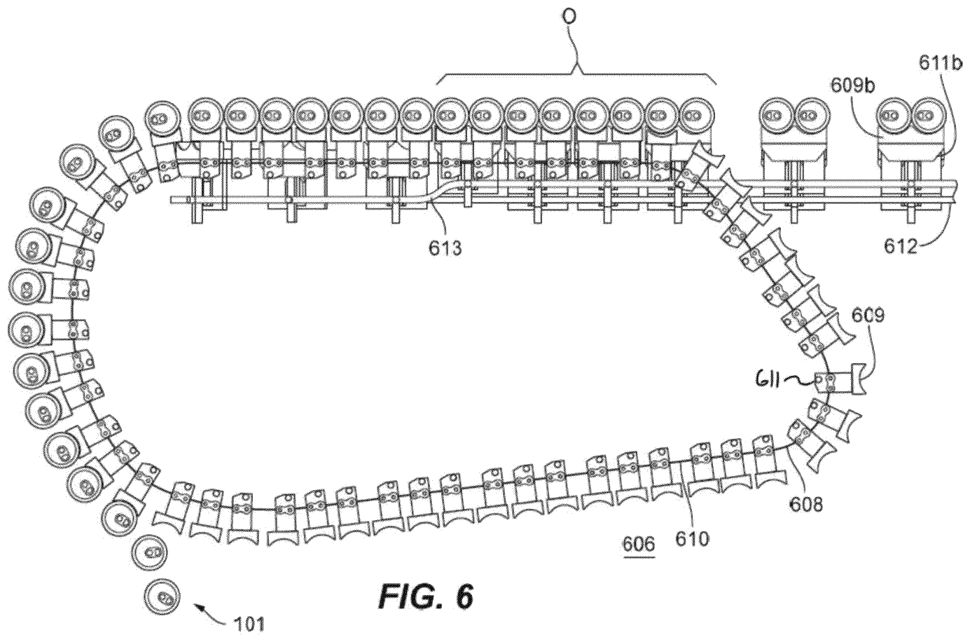

Referring now to FIG. 6, which illustrates an example of grouping module 606 of system 100. The example of system 100 shown in FIG. 6 shares many common features with the examples of system 100 shown in FIGS. 1-5. In the example of system 100 shown in FIG. 6, like numerals have, where possible, been used to denote like parts, albeit with the addition of the prefix “600” to indicate that these features belong to a sixth example of system 100.

In one or more examples, grouping module 606 includes track 608. Track 608 is a single oval track. Grippers 609 move containers 101 along track 608. Each gripper 609 is moved about track 608 by chain 610.

In one or more examples, track 608 of grouping module 606 is an irregular or oblong track (e.g., as with the example of track 408 shown in FIG. 4). In one or more examples, second track 612 is disposed in a vertical plane that receives containers 101 from track 608.

Each of the examples shown in FIGS. 1-6 include unique benefits, as will be described herein below.

The following portion of the present disclosure refers to examples of conveying module 102, 202 (e.g., as shown in FIGS. 1 and 2). It can be appreciated that any of the examples of grouping module 106, 206, 306, 406, 506, 606 can be used with any of the examples of conveying module 102, 202.

Referring now to FIGS. 1 and 2, in one or more examples, each conveying module 102, 202 receives a stream of containers 101. At this point, the stream of containers 101 typically does not have spacing between each container 101.

In one or more examples, as the stream of containers 101 reaches conveying module 102, 202, the stream meets first star-wheel 122, 222. First star-wheel 122, 222 is configured to help straighten the stream of containers 101 and feed containers 101 of the stream to metering screw 124, 224.

In one or more examples, metering screw 124, 224 creates a pitch or a predetermined spacing “S” (e.g., as shown by metering screw 224 in FIG. 2) between each of containers 101. Metering screw 124, 224 then feeds the spaced stream of containers 101 to second star-wheel 126, 226.

Referring now to FIG. 2, in one or more examples, second star-wheel 226 has a different shape than first star-wheel 222. As an example, second spacing 228b between centers of adjacent second divots 232b of second star-wheel 226 is larger than first spacing 228a between centers of adjacent first divots 232a of first star-wheel 222. As another example, second teeth 234b of second star-wheel 226 are wider that first teeth 234a of first star-wheel 222. However, the size of divots 232a, 232b of each of first and second star-wheels 222, 226 remains the same, in order to accept and handle containers 101 of the same diameter.

In one or more examples, divots 232a, 232b of star-wheels 222, 226 can be non-circular to convey non-circular containers 101, such as juice boxes, milk cartons, or motor oil.

In one or more examples, second star-wheel 226 typically has a smaller diameter and spins faster than first star-wheel 222. This combination of star-wheels 222, 226, taken alone and in combination with others, allows for a more compact footprint of conveying module 202 and of the overall system 100.

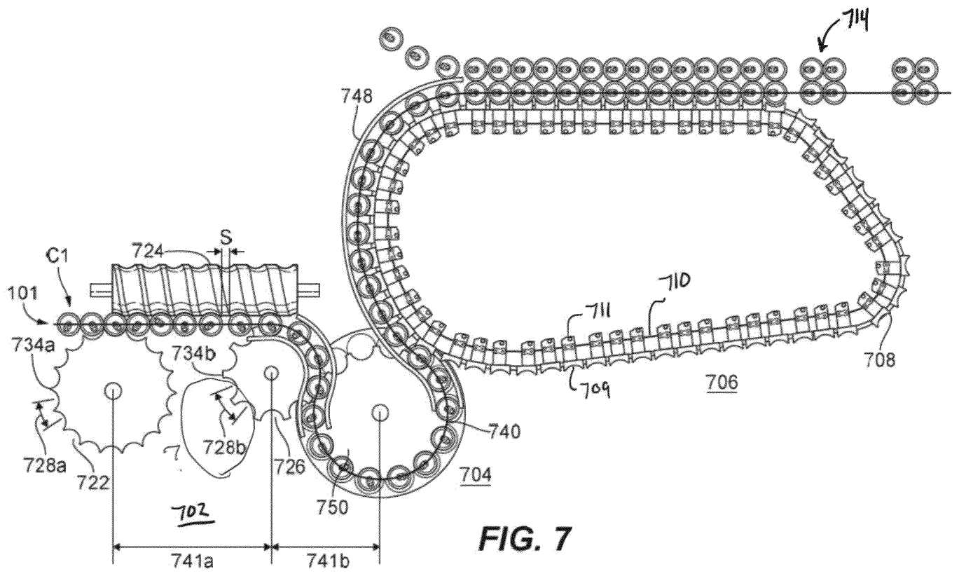

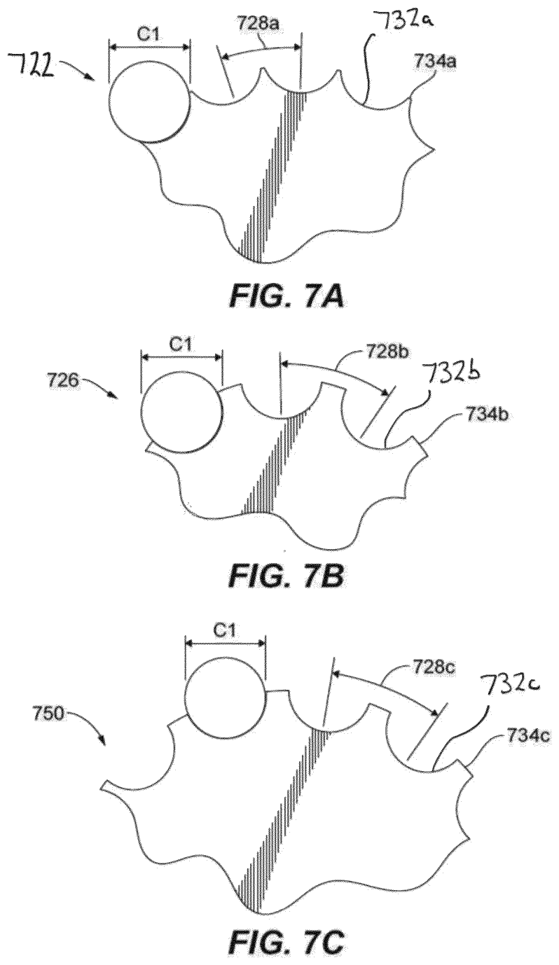

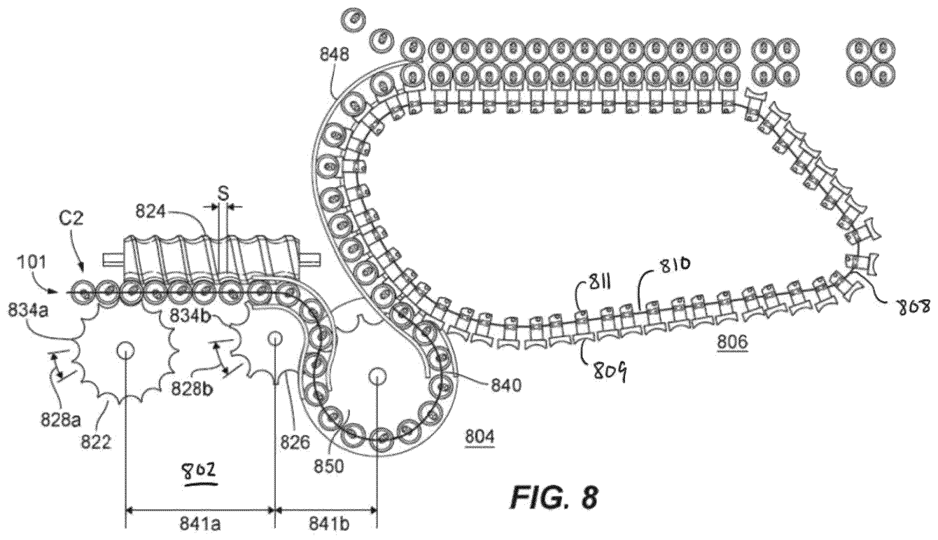

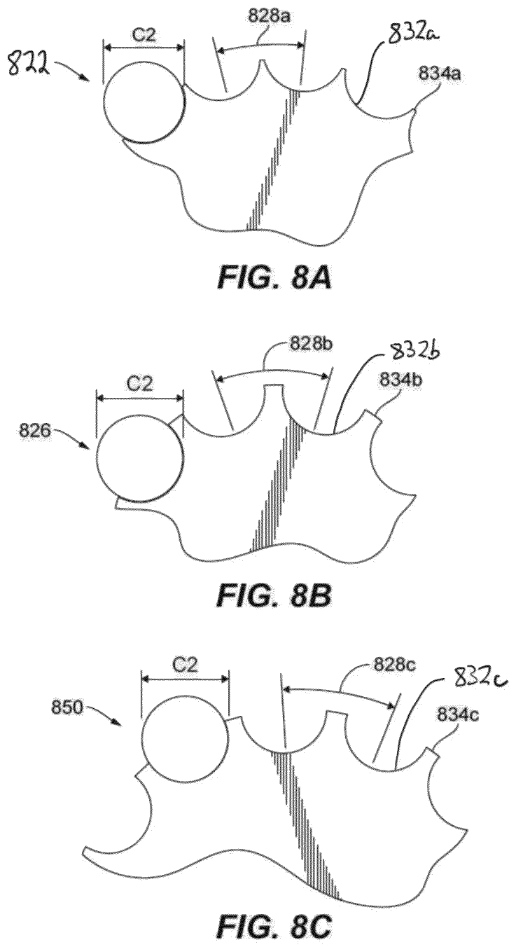

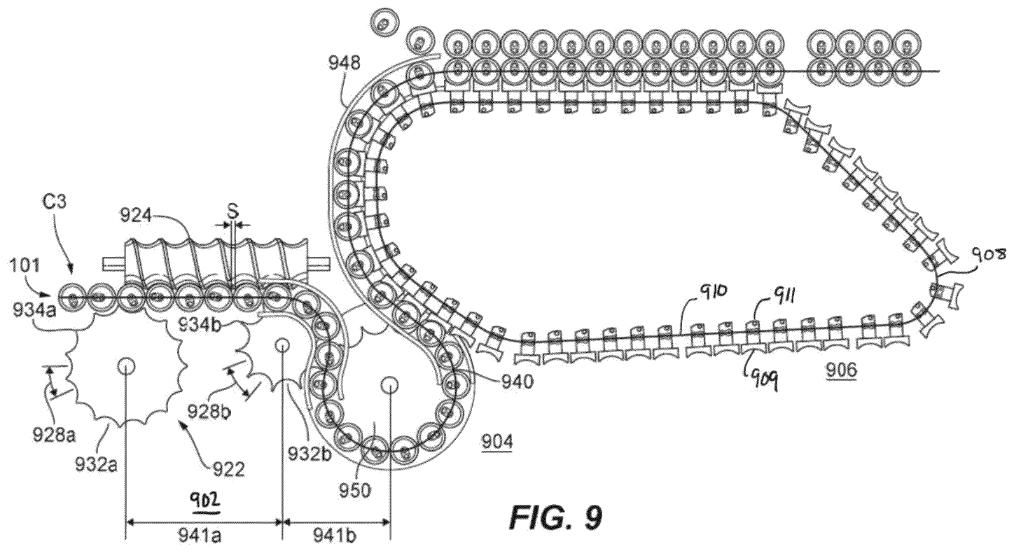

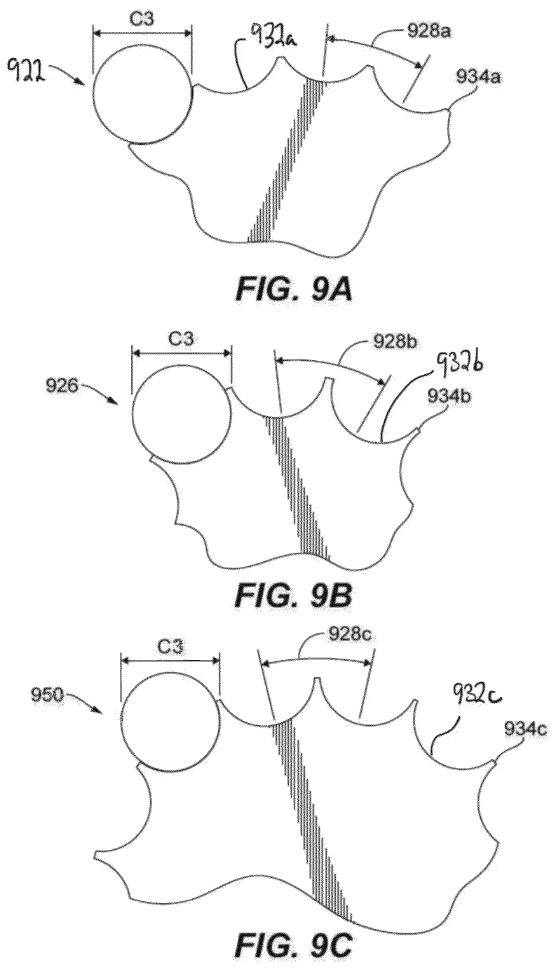

Referring now to FIGS. 7-9, which illustrate examples of system 100. The example of system 100 shown in FIG. 7 shares many common features with the examples of system 100 shown in FIGS. 1-6. In the example of system 100 shown in FIG. 7, like numerals have, where possible, been used to denote like parts, albeit with the addition of the prefix “700” to indicate that these features belong to a seventh example of the system 100. The example of system 100 shown in FIG. 8 shares many common features with the examples of system 100 shown in FIGS. 1-7. In the example of system 100 shown in FIG. 8, like numerals have, where possible, been used to denote like parts, albeit with the addition of the prefix “800” to indicate that these features belong to an eighth example of system 100. The example of system 100 shown in FIG. 9 shares many common features with the examples of system 100 shown in FIGS. 1-8. In the example of system 100 shown in FIG. 9, like numerals have, where possible, been used to denote like parts, albeit with the addition of the prefix “900” to indicate that these features belong to a ninth example of system 100.

Referring to FIG. 7, in one or more examples, the stream of containers 101 forms path 740 for the stream of containers 101 from first star-wheel 722 to track 708 of grouping module 706. Path 740 is defined by a travel path of the center of each container 101. Path 740 stays substantially the same even if the diameter of containers 101 changes (e.g., after switching out star-wheels to change container size as described above).

When comparing FIGS. 7, 8 and 9, containers 101 of FIG. 7 are smaller than containers 101 of FIGS. 8 and 9. However, path 740, 840, 940 of the centers of containers 101 is substantially the same, starting from first star-wheel 722, 822, 922 of conveying module 702, 802, 902 through third star-wheel 750, 850, 950 of orienting module 704, 804, 904. In one or more examples, path 740, 840, 940 is maintained by swapping-out first star-wheel 722, metering screw 724, second star-wheel 726 and third star-wheel 750 for a corresponding one of these parts (e.g., first star-wheel 822, 922; metering screw 824, 924; second star-wheel 826, 926; and third star-wheel 850, 950).

In one or more examples, first star-wheel 722, metering screw 724, second star-wheel 726 and third star-wheel 750 may be swapped out for corresponding parts, for example, the corresponding parts having the same number of teeth 734a, 734b, 734c and divots 732a, 732b, 732c (e.g., as shown in FIGS. 7A-7C), but deeper and wider divots 732a, 732b, 732c, and thinner teeth 734a, 734b, 734c (e.g., for larger containers 101 having a larger diameter C1) or thicker teeth 734a, 734b, 734c and narrower divots 732a, 732b, 732c (e.g., for smaller containers 101 having a smaller diameter C1).

FIGS. 7A-7C illustrate details of examples of each of the star-wheels 722, 726, 750. FIGS. 8A-8C illustrate details of examples of each of star-wheels 822, 826, 850. The examples of star-wheels 822, 826, 850 shown in FIGS. 8A-8C share many common features with the examples of star-wheels 722, 726, 750 shown in FIGS. 7A-7C. In the examples of star-wheels 822, 826, 850 shown in FIGS. 8A-8C, like numerals have, where possible, been used to denote like parts, albeit with the addition of the prefix “800” to indicate that these features belong to another example. The examples of star-wheels 922, 926, 950 shown in FIGS. 9A-9C share many common features with the examples of star-wheels 722, 726, 750 shown in FIGS. 7A-7C and the examples of star-wheels 822, 826, 850 shown in FIGS. 8A-8C. In the examples of star-wheels 922, 926, 950 shown in FIGS. 9A-9C, like numerals have, where possible, been used to denote like parts, albeit with the addition of the prefix “900” to indicate that these features belong to another example.

In one or more examples, first star-wheel 722, metering screw 724, second star-wheel 726 and third star-wheel 750 (e.g., shown in FIGS. 7 and 7A-7B) can be interchanged, as needed, with first star-wheel 822, metering screw 824, second star-wheel 826 and third star-wheel 850 (e.g., shown in FIGS. 8 and 8A-8C) or with first star-wheel 922, metering screw 924, second star-wheel 926 and third star-wheel 950 (e.g., shown in FIGS. 9 and 9A-9C).

Referring again to FIG. 7, in one or more examples, an axis on which each of star-wheels 722, 726, 750 rotates stays the same after interchanging star-wheels 722, 726, 750. Further, first distances 741a between first star-wheel 722 and second star-wheel 726 and second 741b between second star wheel 726 and third star-wheel 750 stay the same after interchanging star-wheels 722, 726, 750, for example, with the star-wheels 822, 826, 850 (e.g., shown in FIGS. 8 and 8A-8C) or with star-wheels 922, 926, 950 (e.g., shown in FIGS. 9 and 9A-9C), which are labeled 841a and 841b in FIGS. 8 and 941a and 941b in FIG. 9.

In one or more examples, star-wheels 722, 726, 750, 822, 826, 850, 922, 926, 950 are left on the same vertical axels and metering screw 724, 824, 924 is left on the same horizontal axel. This allows system 100 to be easily changed for an infeed container 101 with a different diameter (e.g., different can diameter C1 as shown in FIGS. 7-9).

As seen in FIGS. 7-9, path 740, 840, 940 of containers 101, after orienting module 704, 804, 904, is different from FIG. 7 to FIG. 8 to FIG. 9. In previously used systems, the placement of each module differs from FIG. 7 to FIG. 8 to FIG. 9, which, in turn, required more movement of modules and lengthier changeover times between different sized and/or shaped containers 101. System 100 disclosed herein saves time in changeovers (e.g., for different can sizes) and reduces the possibility of errors in those changeovers because less parts must be moved to accommodate differing parts.

Referring again to FIGS. 7-9, in one or more examples, as each container 101 passes second star-wheel 726, 826, 926, container 101 is fed to orienting module 704, 804, 904.

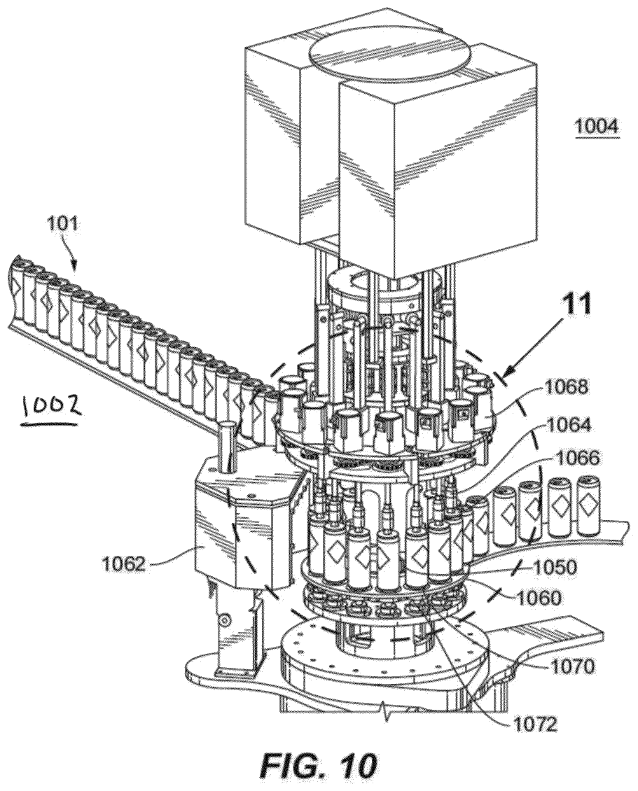

Referring now to FIG. 10, which illustrates an example of orienting module 1004. Orienting module 1004 is an example of the any of orienting modules 104, 204, 704, 804, 904 (e.g., as shown in FIGS. 1, 2, 7, 8 and 9).

In one or more examples, orienting module includes base 1060. Base 1060 supports the incoming containers 101.

In one or more examples, orienting module 1004 includes camera 1062. Camera 1062 is located to the side of base 1060. Camera 1062 is configured for scanning container 101 entering and/or being oriented by orienting module 1004.

In one or more examples, orienting module 1004 includes a plurality of turning members 1064 (e.g., herein referred to collectively as turning members and individually as turning member). Each of turning members 1064 is moveably positioned above base 1060. Turning members 1064 contact and turn containers 101.

In one or more examples, orienting module 1004 includes a processor (not shown).

The processor is operatively connected to camera 1062. The processor is adapted (e.g., operable or programmed) to analyze an initial orientation of containers 101 (e.g., before they are properly oriented).

In one or more examples, it is considered that camera 1062 is required to scan every single container 101. In one or more examples, it is considered that camera 1062 is only required to scan every second, or third, or fourth container 101.

Depending, for example, on downstream packaging steps and/or client specifications, each and every container 101 might be required to face the same direction. After the incoming (e.g., initial) orientation of containers 101 has been analyzed, the processor computes a necessary correction. Each container 101 may need a different correction from another container 101 because the incoming orientation could be different and/or because a final (e.g., desired) orientation may need to be different for each container 101.

In one or more examples, multiple containers 101 can be used to create a single large graphic when placed adjacent to each other within the package. Adjacent containers 101 within one package can have a different orientation showing a different graphic or portion of a graphic to a customer. Alternatively, adjacent containers 101 can form one large graphic seen across multiple containers. For instance, the graphic “CANS” can consist of four containers. Each container 101 can be showing either a ‘C’, an ‘A’, an ‘N’ or an ‘S’.

In one or more examples, third star-wheel 1050 of orientation module 1004 (e.g., may also referred to as orientation module star-wheel or orientation star-wheel) is positioned above rotatable base 1060 to help secure containers 101 as they rotate past camera 1062. As containers 101 move past camera 1062, third star wheel 1050 helps guide them and provides further stability as containers 101 get oriented.

In one or more examples, third star-wheel 1050 of orienting module 1004 has the same spacing between centers of adjacent divots as the second star-wheel (not shown in FIG. 10) of conveying module 1002, as well as the same tooth thickness. In one or more examples, it may be important to maintain spacing between each container 101 so that camera 1062 is able to properly identify the incoming orientation of each container 101. Without spacing between each container 101, adjacent containers 101 may be recognized as a single item by camera 1062 and may not be able to transmit required information to the processor.

Referring still to FIG. 10, in one or more examples, each turning member 1064 corresponds to one container 101. In order to turn each container 101, turning member 1064 moves down in order to come into contact with container 101. As turning member 1064 moves down, disc 1066, located on the bottom of each turning member 1064, contacts a top of each container 101, for example, when turning member 1064 actuates from a retracted position to a deployed position. When disc 1066 comes in contact with each container 101, each turning member 1064 rotates each container 101 a necessary amount to place container 101 in the desired orientation.

In one or more examples, a plurality of surfaces 1070 (herein referred to collectively as surfaces and individually as surface) is located within base 1060. Each of surfaces 1070 corresponds to one of turning members 1064 and to one of containers 101. Surfaces 1070 are also operatively connected to the processor (not shown) and are programmed to turn the same direction and the same amount as each of turning members 1064. Thus, containers 101 are turned evenly from the top and from the bottom, further ensuring stability during turning.

In one or more examples, motor 1072 for each of surfaces 1070 is located below the top surface of base 1060. The particular orientation, with moving turning members 1064 above containers 101 and a vertically stationary surface 1070 below the containers, allows for a smaller motor and smaller turning turret, since each container 101 does not need to be moved vertically. Once containers 101 are properly oriented, containers 101 are moved to the grouping module (not shown in FIG. 10).

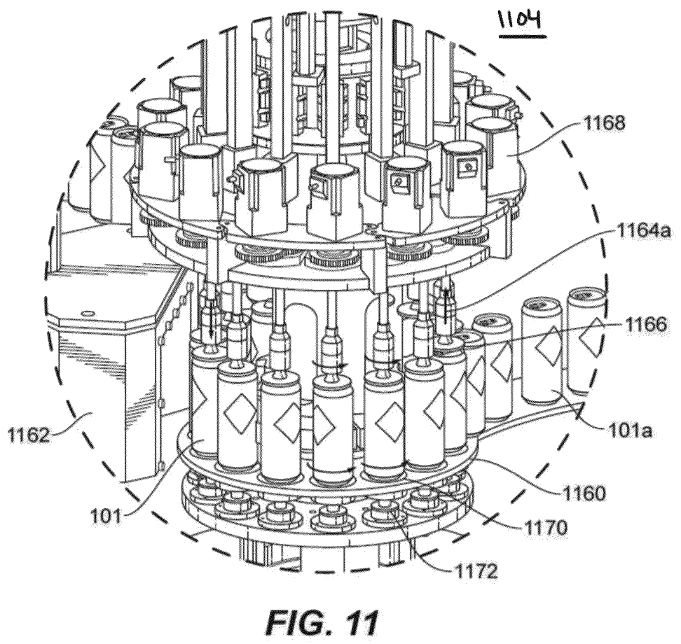

Referring now to FIG. 11, which illustrates an example of a portion of orientation module 1104. The example of orientation module 1104 depicts a subsequent view in which it is possible to appreciate the now oriented containers 101a, which were previously oriented in different directions, as well as the now retracted turning members 1164a, which were previously in contact with the tops of containers 101. The example of orientation module 1104 shown in FIG. 11 shares many common features with the example of orientation module 1004 shown in FIG. 10. In the example of orientation module 1104 shown in FIG. 11, like numerals have, where possible, been used to denote like parts, albeit with the addition of the prefix “1100” to indicate that these features belong to another example of the orientation module.

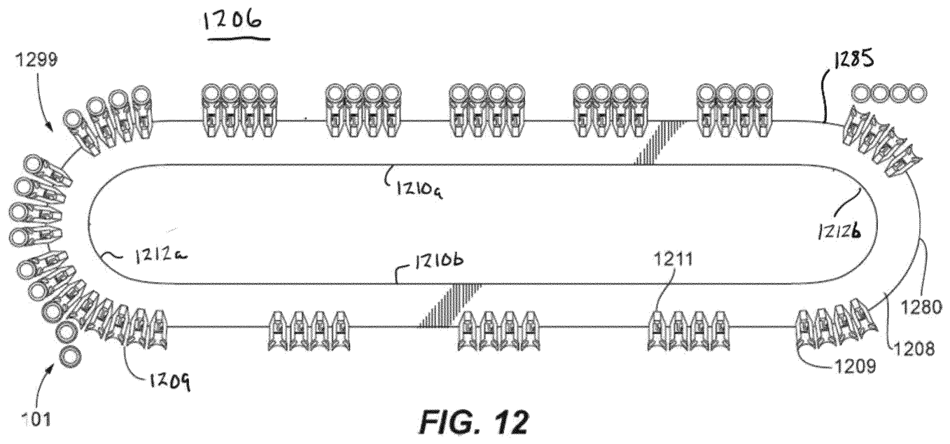

Referring now to FIG. 12, which illustrates an example of grouping module 1206. The example of grouping module 1206 shown in FIG. 12 shares many common features with the examples of grouping module 106, 206, 306, 406, 506, 606, 706, 806, 906 shown in FIGS. 1-7, 8 and 9. In the example of grouping module 1206 shown in FIG. 12, like numerals have, where possible, been used to denote like parts, albeit with the addition of the prefix “1200” to indicate that these features belong to another example of the grouping module.

In one or more examples, after containers 101 are oriented within the orienting module (e.g., not shown in FIG. 12), the stream of containers 101 is passed the orienting module. Grouping module 1206 is responsible for grouping a necessary number of containers 101 together (e.g., to begin forming packs of containers 101 for subsequent packaging), while at the same time ensuring that the orientation of each individual container 101 remains unchanged from the orientation that was received from the orienting module. As described above, a number of possibilities are presented for taking the stream of containers 101 and grouping them while ensuring that the desired orientation is maintained.

FIG. 12 illustrates an example of grouping module 1206 (e.g., as previously depicted in the example of the grouping module 206 shown in FIG. 2). Grouping module 1206 includes track 1208. Track 1208 is single oval track and is oriented in a horizontal plane. Grippers 1209, which push the containers 101 along track 1208, are individually attached to lugs 1211. In one or more examples, each lug 1211 is actuated by the linear servo drive (not shown in FIG. 12). The linear servo drive (e.g., servo drive 112 shown in FIG. 1) allows for programming an individual lug 1211 or groups of lugs 1211 speed profiles along track 1208 for lugs 1211 to follow.

As containers 101 are circulated from the orienting module to grouping module 1206, lugs 1211 move attached grippers 1209 in place to receive containers 101. Lugs 1211 are arranged prior to picking up containers 101 in queuing section 1280 and accelerate around first curved portion 1212a of track 1208 once a desired group of containers 101 (e.g., in this case it is four containers 101) have been contacted in order to create gap 1299 between the group and the next group of containers 101, while maintaining the desired orientation of containers 101 of the group of containers 101.

Once the group of containers 101 has reached first straight section 1210a of track 1208, the group of containers 101 travel at a constant speed. At this point, various packaging steps can take place. Each formed group of containers 101 can meet a group from the mirrored set of modules (e.g., module set II shown in FIG. 1) to make a single pack (e.g., pack 114 as shown in FIG. 1), such as an eight-pack, a four-pack, and the like.

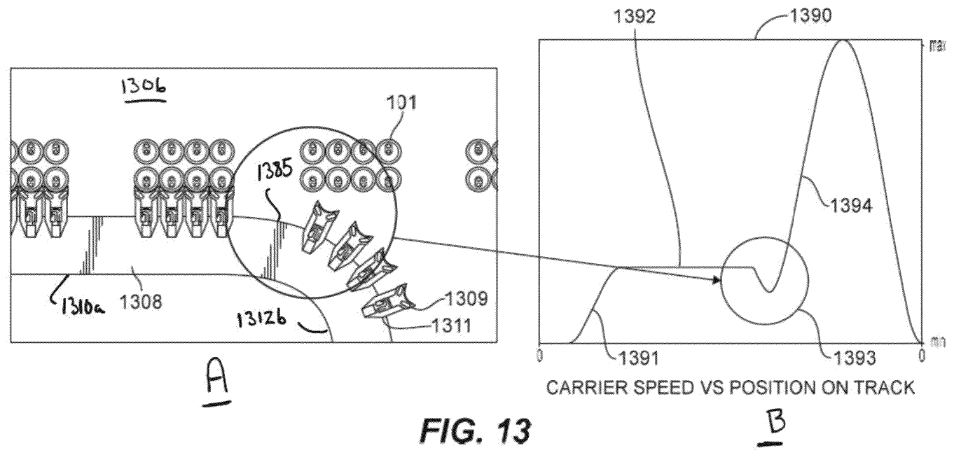

Referring now to FIG. 13A, which illustrates an example of a portion of grouping module 1306. The example of grouping module 1306 shown in FIG. 13 shares many common features with the examples of grouping module 106, 206, 306, 406, 506, 606, 706, 806, 906, 1206 shown in FIGS. 1-7, 8, 9 and 12. In the example of grouping module 1306 shown in FIG. 13, like numerals have, where possible, been used to denote like parts, albeit with the addition of the prefix “1300” to indicate that these features belong to another example of the grouping module.

In one or more examples, as lugs 1311 travel around track 1308, lugs 1311 follow a programmed speed profile. This allows any plurality of lugs 1311 to be arranged together to form a desired group of lugs 1311 (e.g., two together, three together, etc.). After lugs 1311 and grippers 1309 have reached the end of the first straight section 1310a of the track 1308, lugs 1311 and grippers 1309 peel away from containers 101, for example, at location 1385 of track 1308.

In one or more examples, a method used to peel away grippers 1309 and lugs 1311 is by slowing down grippers 1309 and lugs 1311 to allow containers 101 to keep moving forward at the point where first straight section 1310a of the track 1308 turns to second curved portion 1312b of the track 1308. This speed profile allows for gripper 1309 and container 101 to gain separation from each other before gripper 1309 changes directions, thus, preventing grippers 1309 from shifting, turning, or otherwise disturbing containers 101. After grippers 1309 are free of containers 101, they accelerate around the rest of second curved portion 1312b of track 1308 and the second straight portion (not shown in FIG. 13) of track 1308 to join lugs 1311 in the queuing section (e.g., queuing section 1280 shown in FIG. 12).

Referring now to FIG. 13B, which illustrates a graphical representation of the velocity profile 1390 for the lug (e.g., lug 1311 shown in FIG. 13A) and the gripper (e.g., gripper 1309 shown in FIG. 13A), as described above. The profile 1390 includes acceleration portion 1391, in which lug 1311 and, thus, gripper 1309 is accelerated immediately after contacting the last container 101 in the intended group of containers 101 (e.g., the second in the package of two and the third in a package of four). Acceleration portion 1391 allows the group of lugs 1311 to produce the gap (e.g., gap 1299 shown in FIG. 12) from the next group of lugs 1311. Afterwards the profile 1390 includes constant speed portion 1392, in which containers 101 are moved along at a constant speed while packaging steps are performed on containers 101. Afterwards, the profile includes a deceleration portion 1393, in which lugs 1311 and grippers 1309 are decelerated (e.g., slowed down) as the containers 101 are moved away by another conveyor or lug and carrier combination (e.g., as described above) to drop off containers 101 smoothly without disturbing them. After the containers 101 are dropped off by grippers 1309, the profile 1390 includes a second acceleration portion 1394, in which lugs 1311 and grippers 1309 accelerate to the highest velocity to return to the queuing section (e.g., queuing section 1280 shown in FIG. 12) before picking up another container 101.

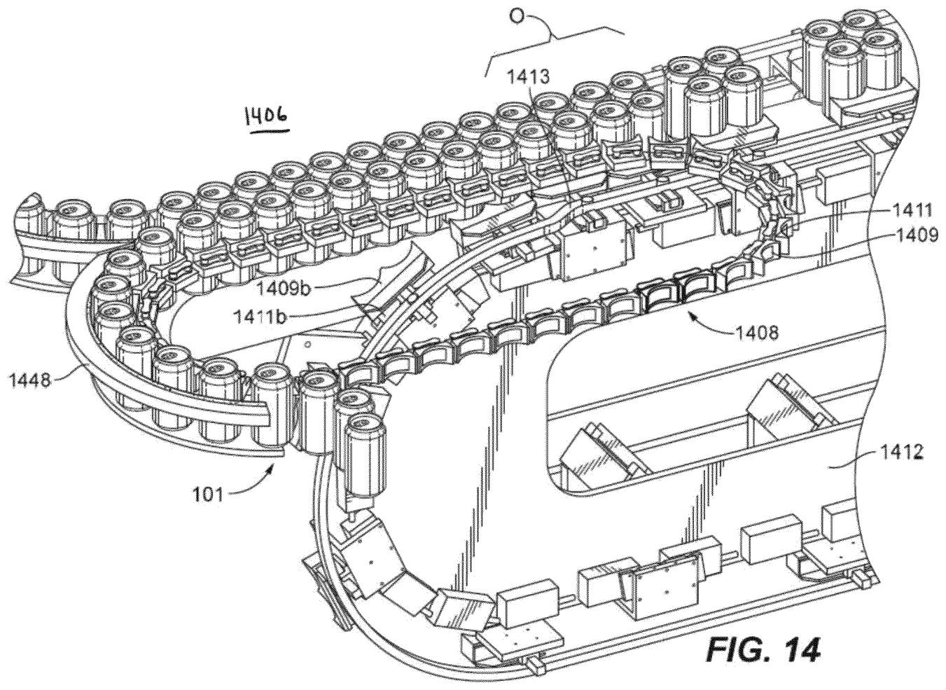

Referring now to FIG. 14, which illustrates an example of a portion of system 100. The example of system 100 shown in FIG. 14 shares many common features with the examples of system 100 shown in FIGS. 1-7, 8, 9 and 10-13. In the example of system 100 shown in FIG. 14, like numerals have, where possible, been used to denote like parts, albeit with the addition of the prefix “1400” to indicate that these features belong to another example of system 100.

In one or more examples, lugs 1411 are each attached and driven by a linear chain (not shown in FIG. 14). Lugs 1411 and containers 101 travel at a constant velocity around track 1408. In one or more examples, system 100 conveys the stream of containers 101 to a downstream packaging station or to set of second lugs 1411b and second grippers 1409b that move along second track 1412 and that would produce the groups of containers 101.

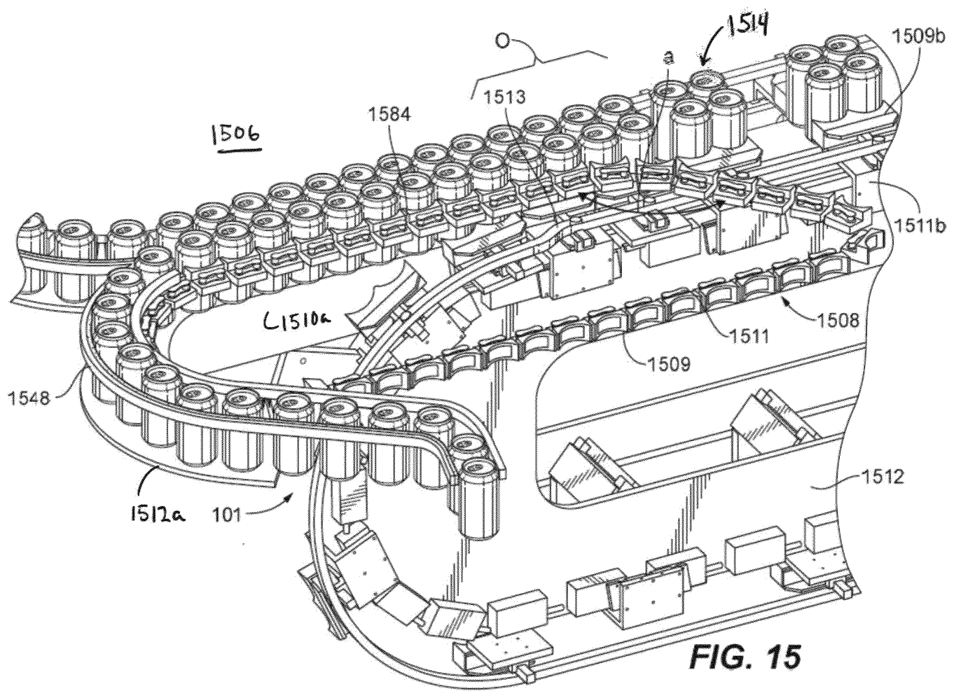

Referring now to FIG. 15, which illustrates an example of a portion of system 100. The example of system 100 shown in FIG. 15 shares many common features with the examples of system 100 shown in FIGS. 1-7, 8, 9 and 10-14. In the example of system 100 shown in FIG. 15, like numerals have, where possible, been used to denote like parts, albeit with the addition of the prefix “1500” to indicate that these features belong to another example of system 100.

In one or more examples, track 1508 is horizontal but not strictly oval in shape. In one or more examples, track 1508 is skewed at one point, for example, at location “a”. The oblong shape allows for a smoother departure of grippers 1509 from each of containers 101, since the turning angle of grippers 1509 is not as sharp. This may decrease the chances of gripper 1509 shifting container 101 as it peels away.

Each of the examples shown in FIGS. 14 and 15 can be paired with the second track (e.g., second track 1412 shown in FIG. 14 and second track 1512 shown in FIG. 15), which is responsible for receiving containers 101 from the linear chain and grouping them, again while not disturbing and disorienting containers 101.

Referring to FIG. 15, in one or more examples, grouping module 1506 include second track 1512 to move second lugs 1511b and second grippers 1509b after receiving containers 101 from track 1508. Second grippers 1509b group containers 101 into packs 1514 and move packs 1514 along also without changing the orientation of each container 101. While first grippers 1509 and first lugs 1511 move about the horizontal plane, second grippers 1509b and second lugs 1511b move about a vertical plane. Further, second track 1512 follows an oval but includes a horizontal protuberance 1513, which forces each second lug 1511b and attached second gripper 1509b towards the container 101.

In one or more examples, second track 1512 can include a linear motor servo drive (not shown) to actuate each of second lugs 1511b along second track 1512. Second lugs 1511b and second grippers 1509b of second track 1512 are positioned below grippers 1509 and lugs 1511 of track 1508 when both sets contact container 101. This allows system 100 to handle taller containers 101.

In one or more examples, track 1508 (e.g., first track) and second track 1512 partially overlap each other in an area indicated in FIG. 15 by reference the letter “O” and are partially aligned in the same direction, such that grippers 1509 of track 1508 and second grippers 1509b of second track 1512 contact container 101 at the same time and for a period of time in area “O” as track 1508 hands containers 101 off to second track 1212. The overlap of the tracks also allows for a more compact floor space arrangement because two vertical or two horizontal tracks would not be able to overlap without having to move container 101 vertically.

In one or more examples, during handing off of container 101 from gripper 1509 to second gripper 1509b, container 101 is simultaneously driven by other containers 101 of the stream of containers 101, for example, by second grippers 1509b along a straight path of track 1508. Grippers 1509 are withdrawn as they peel away from contacting container 101 of the stream of containers 101.

In one or more examples, gripper 1509 and second gripper 1509b drive the respective container 101 at the same velocity when both are in contact with container 101. This arrangement allows for a smooth transition from containers 101 being pushed along by lugs 1511 and grippers 1509 to later containers 101 being pushed along by second lugs 1511b and second grippers 1509b.

In one or more examples, as lugs 1511 follow track 1508 and are connected to corresponding grippers 1509, curved guide 1548 is placed at a location where grippers 1509 pick up containers 101 from the orienting module (not shown in FIG. 15) and follows track 1508 to the first straight section 1510a. Guide 1548 helps bias containers 101 against a body of each one of grippers 1509.

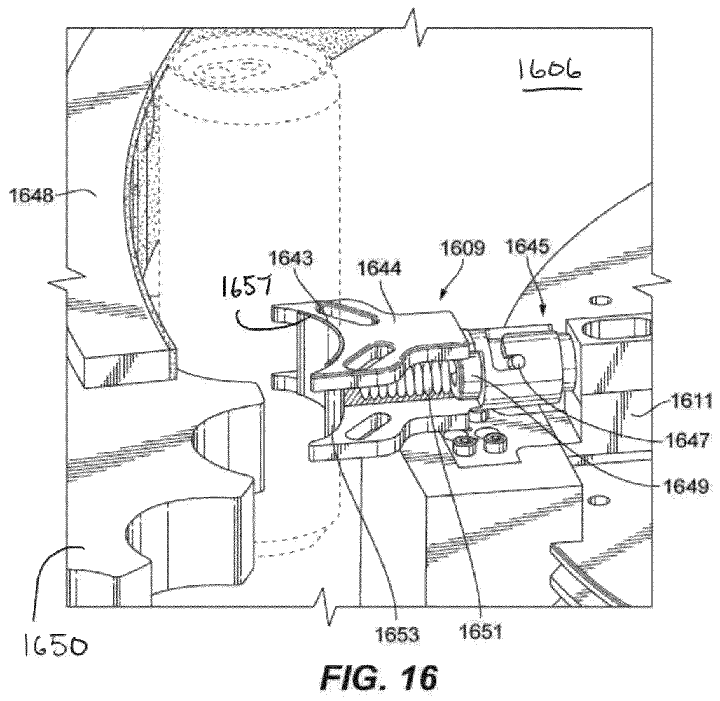

Referring now to FIG. 16, which illustrates an example of gripper 1609. Gripper 1609 is an example of any of the examples of gripper 109, 209, 309, 409, 509, 609, 709, 809, 909, 1209, 1309, 1409 shown in FIGS. 1-7, 8, 9, 12, 13A, 14 and 15. FIG. 16 depicts an example of gripper 1609 used by an example of grouping module 1606.

In one or more examples, gripper 1609 includes gripper body 1644. Gripper body 1644 partially surrounds and drives a corresponding container 101 along the track (not shown in FIG. 16). In one or more examples, gripper body 1644 includes receiving end 1643 and locking end 1645, opposite receiving end 1643. In one or more examples, gripper body 1644 is coupled to lug 1611 at or by locking end 1645.

In one or more examples, coupling 1647 is used to couple gripper body 1644 and lug 1611 together. In one or more examples, coupling 1647 is located on locking end 1645 of gripper body 1644. Coupling 1647 may be any suitable type or style of mechanical coupling or connector assembly, such as a two-part interconnection assembly. In an example, coupling 1647 is a bayonet style lock. This coupling style allows for an easy changeover of gripper 1609 depending, for example, on the size and/or shape of container 101.

In one or more examples, each lug 1611 includes shaft 1649. Shaft 1649 extends horizontally and is configured to connect to coupling 1647 at locking end 1645 of gripper body 1644.

In one or more examples, dampener 1651 is positioned within or is otherwise coupled to or integrated with gripper body 1644. In one or more examples, dampener 1651 is or takes the form of a spring, a dash pot, a cushion, or the like, which allows for smoothly reacting to container 101 that is out of place and also acts as a shock absorber in order to not damage container 101 when gripper 1609 comes into contact with container 101.

In one or more examples, insert 1653 is placed in a concave portion of receiving end 1643 of gripper body 1644 (e.g., applied to or on concave gripper surface 1657), such that, when insert 1652 comes in contact with container 101, insert 1653 of receiving end 1643 helps keep container 101 oriented in the proper position and/or orientation.

In one or more examples, insert 1653 includes a material having a higher coefficient of friction than gripper body 1644, such as of receiving end 1643. In one or more examples, insert 1653 also has a higher coefficient of friction than a contact surface of guide 1648. This combination of friction coefficients allows gripper 1609 to slide container 101 along guide 1648 without container 101 changing an orientation or slipping from gripper 1609, especially along the curved portion of the track (not shown in FIG. 16) where lug 1611 and gripper 1609 are accelerating.

In one or more examples, as gripper 1609 and container 101 move past guide 1648, insert 1653 helps maintain the orientation of the container 101. In one or more examples, insert 1653 can be an adhesive strip, such as fugitive glue. This type of adhesive allows gripper 1609 to keep container 101 from rotating, but also allows gripper 1609 to peel away at the necessary stage without affecting the orientation of container 101. In one or more examples, insert 1653 is, includes, or takes the form of a rubber sheet applied or otherwise coupled to at least a portion of concave gripper surface 1657.

Referring now to FIG. 17, which illustrates an example of a portion of system 100. The example of system 100 shown in FIG. 17 shares many common features with the examples of system 100 shown in FIGS. 1-7, 8, 9 and 10-16. In the example of system 100 shown in FIG. 17, like numerals have, where possible, been used to denote like parts, albeit with the addition of the prefix “1700” to indicate that these features belong to another example of system 100.

In one or more examples, system 100 includes or can be used in conjunction with packaging apparatus 1795. Packaging apparatus 1795 partially overlaps with track 1708 and is configured to overlay packaging 1796 (e.g., cardboard as shown in FIG. 17 or plastic wrap), while grippers 1709 are still in contact with containers 101. This arrangement further ensures that containers 101 keep their intended orientation all the way through the packaging process.

Referring now to FIG. 18, which illustrates an example of a portion of system 100. The example of system 100 shown in FIG. 18 shares many common features with the examples of system 100 shown in FIGS. 1-7, 8, 9 and 10-17. In the example of system 100 shown in FIG. 18, like numerals have, where possible, been used to denote like parts, albeit with the addition of the prefix “1800” to indicate that these features belong to another example of system 100.

In one or more examples, orienting module 1804 receives the stream of container 101 and orients each of containers 101 in the desired orientation. Orienting module 1804 hands off each of containers 101 to grouping module 1806.

In one or more examples, grouping module 1806 includes track 1808. Track 1808 is a single oval track. Grippers 1809 move containers 101 along track 1808. Each of grippers 1809 is coupled to a respective one of lugs 1811. Lugs 1811 are moved along track 1808 by chain 1810.

Orienting module 1804 is configured to orient container 101 in the desired orientation and to hand off container 101 to gripper 1809 as gripper 1809 moves along track 1808.

In one or more examples, gripper 1809 is configured to be releasably coupled to container 101 via vacuum. With gripper 1809 vacuum coupled to container 101, gripper 1809 guides container 101 along a portion of track 1808 and maintains container 101 in the desired orientation.

Use of the vacuum to secure container 101 to gripper 1809 and to maintain container 101 in the desired orientation is advantageous because the vacuum provides a more secure releasable connection compared to only friction, while also reducing the potential of marking container 101 or smearing indicia printed on the surface of container 101.

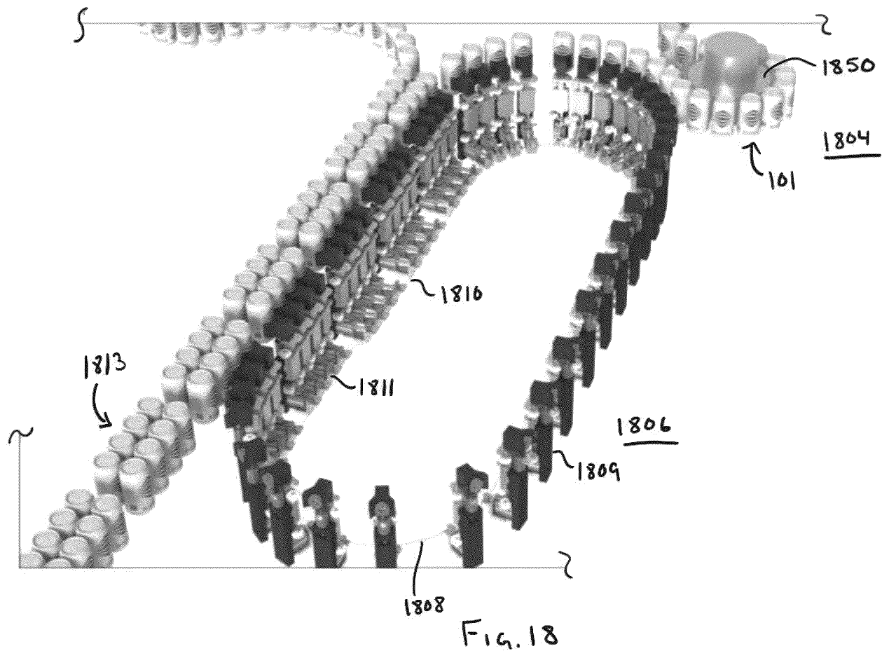

Referring now to FIG. 19, which illustrates an example of a portion of system 100. The example of system 100 shown in FIG. 19 shares many common features with the examples of system 100 shown in FIGS. 1-7, 8, 9 and 10-18. In the example of system 100 shown in FIG. 19, like numerals have, where possible, been used to denote like parts, albeit with the addition of the prefix “1900” to indicate that these features belong to another example of system 100.

In one or more examples, grouping module 1906 includes track 1908. Track 1908 is a single oval track. Grippers 1909 move containers 101 along track 1908. Grippers 1909 are coupled to lugs 1911. Lugs 1911 are moved along track 1908 by the chain (not shown in FIG. 19).

Orienting module 1904 orients container 101 in the desired orientation and hands off container 101 to gripper 1909 as gripper 1909 moves along track 1908.

In one or more examples, gripper 1909 is releasably coupled to container 101 via vacuum. With gripper 1909 vacuum coupled to container 101, gripper 1909 guides container 101 along a portion of track 1908 and maintains container 101 in the desired orientation.

In one or more examples, gripper 1909 is a closed mechanical system. In other words, in one or more examples, gripper 1909 is configured to generate the vacuum used to hold container 101 without the need for an external power or energy source and without the need for an external control signal to drive operation and select actuation of the vacuum. For example, gripper 1909 includes actuator 1956 that is controlled by cam assembly 1954.

Use of cam assembly 1954 to control actuator 1956, which generates the vacuum used to secure container 101 to gripper 1909 in the desired orientation, is advantageous because it reduces the complexity and cost of system 100, particularly, by eliminating power supply lines and/or control lines which must otherwise be coupled to grippers 1909 and be capable of enabling grippers 1909 to move around track 1908.

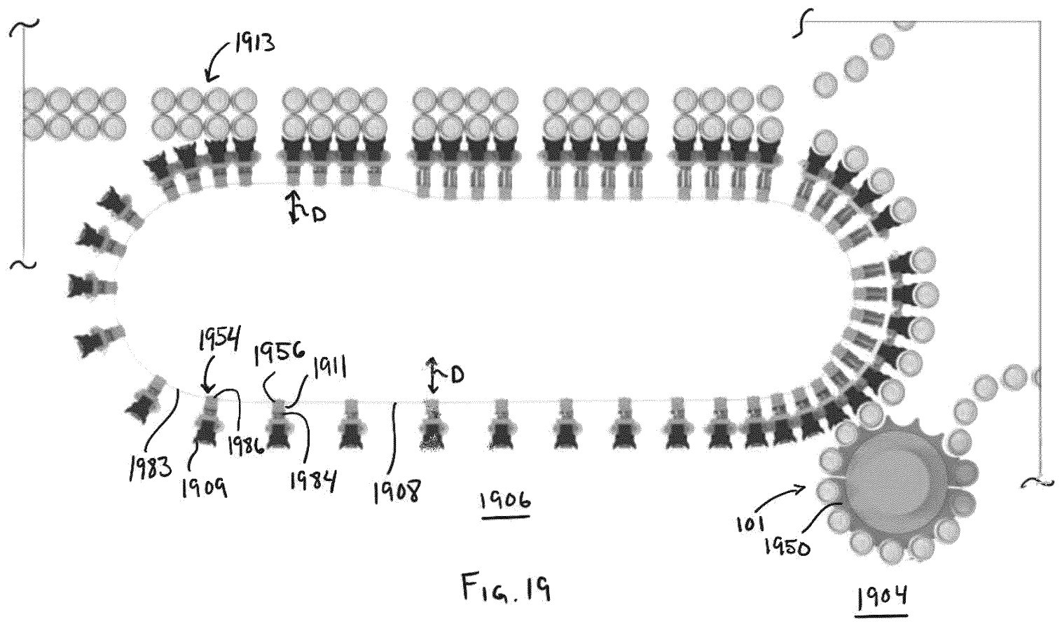

Referring now to FIG. 20, which illustrates an example of gripper 2009. Gripper 2009 is an example of any of the examples of gripper 109, 209, 309, 409, 509, 609, 709, 809, 909, 1209, 1309, 1409, 1609, 1709, 1809, 1909 shown in FIGS. 1-7, 8, 9, 12, 13A and 14-19.

In one or more examples, gripper 2009 includes suction cup 2078. Suction cup 2078 is configured to contact a surface of container 101 and apply the vacuum to container 101 to secure container 101 to receiving end 2043 of gripper 2009 and maintain container 101 in the desire orientation.

In one or more examples, gripper 2009 includes vacuum source 2084. Vacuum source 2084 is coupled to or is otherwise in fluid communication with suction cup 2078. Vacuum source 2084 is configured to generate the vacuum used by gripper 2009 to hold container 101. The vacuum is supplied or otherwise transferred to suction cup 2078 from vacuum source 2084, for example, via vacuum supply line 2088. Vacuum supply line 2088 is any suitable pneumatic line, such as a hose, tube or the like. In one or more examples, vacuum source 2084 is, includes, or takes the form of pneumatic piston 2035.

In one or more examples, gripper 2009 includes actuator 2056. Actuator 2056 is coupled to vacuum source 2084. Actuator 2056 is configured to drive operation of vacuum source 2084 such that vacuum source 2084 generates the vacuum. In one or more examples, actuator 2056 operates to drive pneumatic piston 2035 to generate the vacuum pressure, for example, by selectively moving (e.g., pushing or pulling) drive member 2075 (e.g., piston via piston rod) within drive cylinder 2081 (e.g., in the directions of directional arrow 2033 as shown in FIG. 20). As an example, and as illustrated in FIG. 20, actuator 2056 moves (e.g., pushes) drive member 2075 in a first direction to generate the vacuum and moves (e.g., pulls) drive member 2075 in a second direction, opposite the first direction, to relieve of cease the vacuum.

In one or more examples, gripper 2009 includes pressure gauge 2089. Pressure gauge 2089 is configured to measure or otherwise detect vacuum pressure in the pneumatic circuit, for example, generated by vacuum source 2084 (e.g., pneumatic cylinder 2035) and/or supplied to suction cup 2078.

In one or more examples, gripper 2009 includes check valve 2036. Check valve 2036 is configured to be selectively actuated between a closed position and an open position. In the closed position, check valve 2036 forms a closed pneumatic circuit, for example, between vacuum source 2084 (e.g., pneumatic piston 2035) and suction cup 2078. In the open position, check valve 2036 selectively opens the pneumatic circuit. For example, check valve 2036 operates to evacuate surplus pressure in the pneumatic circuit (e.g., in pneumatic piston 2035) to reset the circuit pressure (e.g., back to approximately zero or atmospheric pressure).

Check valve 2036 operates in such a way that any overpressure in the pneumatic circuit is always evacuated before a subsequent gripping operation on another container 101 such that gripper 2009 is able to replicate the same amount of vacuum in the next cycle. For example, check valve 2036 beneficially prevents a situation in which the pressure in the pneumatic circuit is greater than or equal to zero when pneumatic piston 2035 is reset (e.g., when drive member 2075 is not completely pushed back to a start position) and/or when there is no container 101 coupled to suction cup 2078 such that gripper 2009 is not able to replicate the same amount of vacuum in the next cycle. As an example, check valve 2036 is characterized by a cracking pressure, which refers to a minimum upstream pressure required to open check valve 2036 enough to allow detectable flow. Generally, the cracking pressure for check valve 2036 is as low as possible. In one or more examples, the cracking pressure is approximately 0.05 bar.

In one or more examples, suction cup 2078 is coupled to or extends from receiving end 2043 of gripper 2009. In one or more examples, suction cup 2078 is flexible. Suction cup 2078 being flexible is advantageous because it enables suction cup 2078 to conform to a contour of the surface of container 101 such that suction cup 2078 forms or makes a tight seal with container 101.

In one or more examples, receiving end 2043 of gripper 2009 includes concave gripper surface 2057. Concave gripper surface 2057 is configured (e.g., suitable sized and shaped) to partially surround container 101. For example, concave gripper surface 2057 has a radius of curvature that is approximately equal to that of container 101 such that receiving end 2043 suitable accepts and handles container 101 having a matching diameter. In one or more examples, suction cup 2078 is coupled to and/or extends from concave gripper surface 2057. In this manner, concave gripper surface 2057 appropriately positions container 101 for contact with suction cup 2078 during vacuum coupling with gripper 2009.

In one or more examples, suction cup 2078 includes bellows 2079. For example, suction cup 2078 takes the form of a flexible bellows suction cup. Bellows 2079 include a tubular body with concertinaed sides that enable bellows 2079 to expand and contract.

Suction cup 2078 of gripper 2009, such as a flexible bellows suction cup, is capable of being compressed against the surface of container 101 such that the vacuum can be formed between suction cup 2078 and container 101. The vacuum formed between suction cup 2078 and container 101 is sufficient to avoid packaging rotation of container 101 and maintain container 101 in the desired orientation. Additionally, the vacuum formed between suction cup 2078 and container 101 is sufficient to resist or counter rotation of container 101 (e.g., the urge of container 101 to rotate) in response to centrifugal force 2058 acting on container 101 as gripper 2009 moves container 101 along the curved section of the track (not shown in FIG. 20).

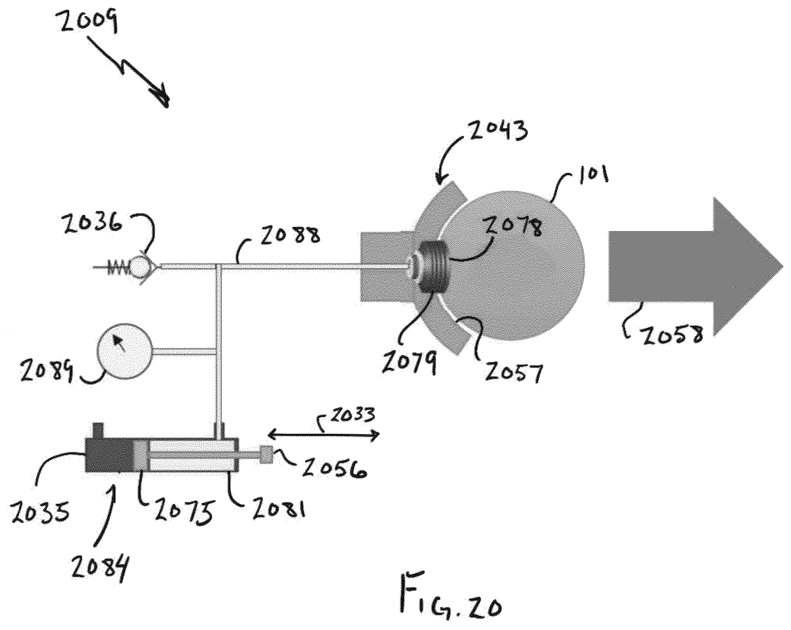

Referring now to FIG. 21, which illustrates a graphical representation of the centrifugal force profile (e.g., centrifugal force 2058 shown in FIG. 19) acting on container 101 as container 101 moves along a portion of the track, such as the first curved portion of the track. In one or more examples, the centrifugal force ranges between approximately 3 Newtons and approximately 9 Newtons, for example, as container 101 accelerates and moves along the curved section of the track. The vacuum pressure applied to container 101 by the gripper is selectively controlled to be sufficient to resist the urge of container 101 to rotate in response to the centrifugal force.

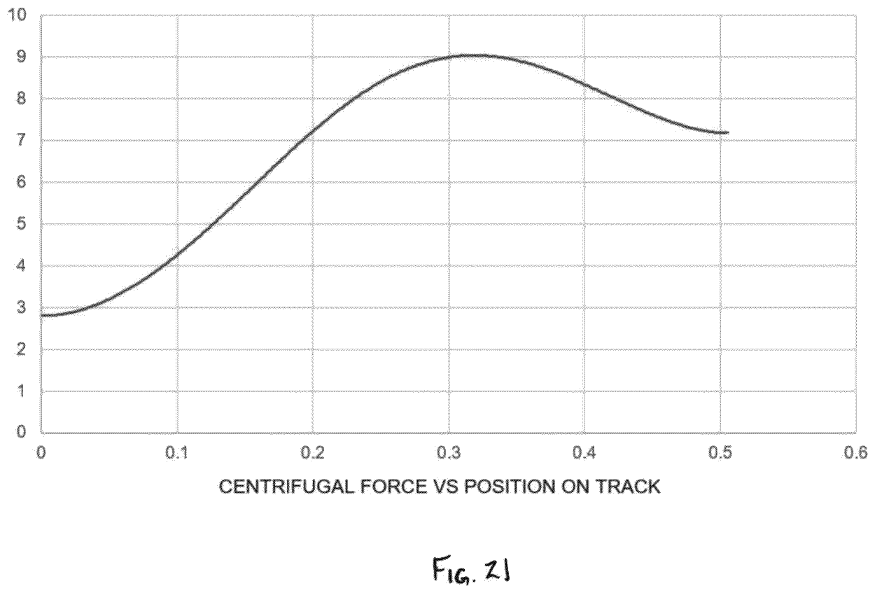

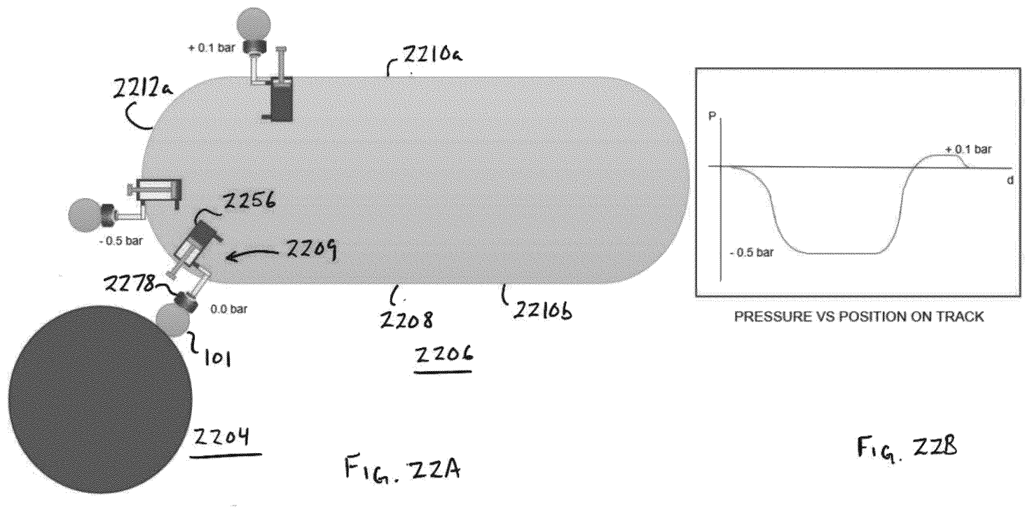

Referring to FIG. 22A, which illustrates an example of a portion of system 100. The example of system 100 shown in FIG. 22A shares many common features with the examples of system 100 shown in FIGS. 1-7, 8, 9 and 10-19. In the example of system 100 shown in FIG. 22A, like numerals have, where possible, been used to denote like parts, albeit with the addition of the prefix “2100” to indicate that these features belong to another example of system 100.

FIG. 22A depicts grippers 2109 moving container 101 along track 2208 and, more particularly, grippers 2109 moving containers 101 along first curved section 2112a of track 2208 in which the centrifugal force acting upon containers 101 urges containers 101 to rotate to a non-desired orientation. In one or more examples, gripper 2109 is configured to selectively control the vacuum pressure applied to container 101 as gripper 2109 moves container 101 along track 2208. In one or more examples, gripper 2109 is configured to vary the vacuum pressure applied to container 101 as gripper 2109 moves container 101 along first curved section 2112a of track 2208.

FIG. 22B illustrates a graphical representation of a pressure profile for the vacuum applied to container 101 by gripper 2109, as gripper 2109 moves along a portion of track 2108 (as shown in FIG. 22A). For the purpose of the present disclosure, vacuum refers to a negative pressure (e.g., soft vacuum) that results from evacuating gas (e.g., air) from a space and reducing the pressure within the space (e.g., between the suction cup and the container). For the purpose of the present disclosure, vacuum pressure refers to a differential pressure that is measured relative to a reference pressure (e.g., equal to gauge pressure). In the examples illustrated in FIGS. 22A and 22B, the reference pressure is atmospheric air pressure (e.g., approximately 1 bar).

Referring to FIGS. 22A and 22B, in one or more examples, gripper 2209 does not generate the vacuum along second straight section 2110b of track 2108 (e.g., the vacuum pressure is approximately 0.0 bar (e.g., atmospheric pressure)). As or immediately after suction cup 2178 contacts the surface of container 101, the vacuum (e.g., negative) pressure is reduced to approximately −0.5 bar. The vacuum pressure of −0.5 bar is maintained as gripper 2109 moves container 101 along first curved section 2112a of track 2108. Afterwards (e.g., at a location along first straight section 2110a of track 2108), the vacuum is ceased (e.g., the pressure raises back to 0.0 bar) such that gripper 2109 can peel away from container 101. In one or more examples, gripper 2109 may apply a small positive pressure (e.g., approximately +0.1 bar) to release container 101 from suction cup 2178, thus, preventing gripper 2109 from shifting, turning, or otherwise disturbing container 101. The ranges of vacuum pressure are provided merely as examples and other values of vacuum pressure may be implemented without departing from the intended structure and operation of gripper 2209 and without departing from the principles of the present disclosure and purpose of system 100.

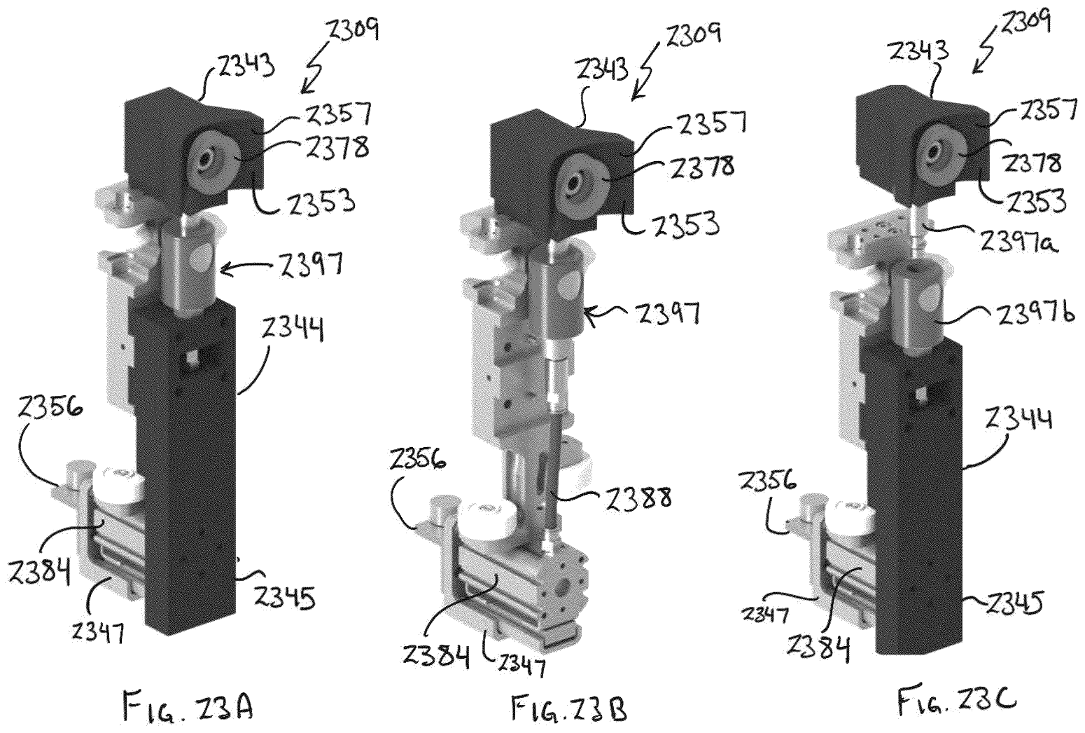

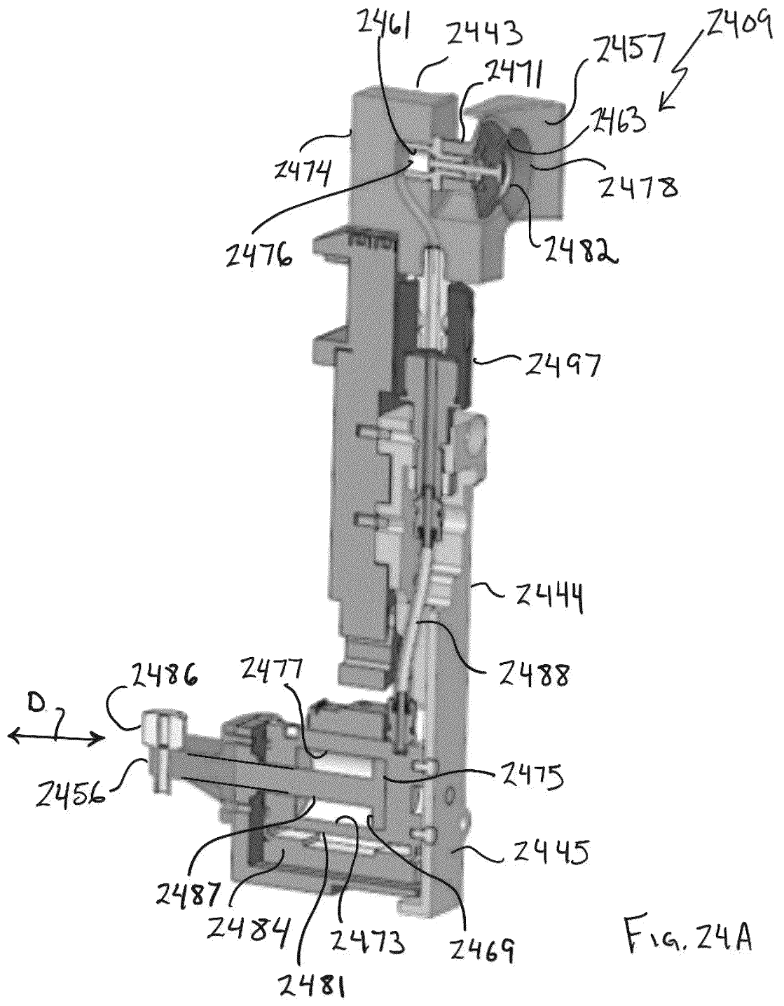

Referring now to FIGS. 23A-23C, which illustrate an example of gripper 2309. The example of gripper 2309 shown in FIGS. 23A-23C shares many common features with the examples of gripper 109, 209, 309, 409, 509, 609, 709, 809, 909, 1209, 1309, 1409, 1609, 1709, 1809, 1909, 2009, 2209 shown in FIGS. 1-7, 8, 9, 12, 13A, 14-20 and 22A. In the example of gripper 2309 shown in FIGS. 23A-23C, like numerals have, where possible, been used to denote like parts, albeit with the addition of the prefix “2300” to indicate that these features belong to another example of the gripper. In other words, gripper 2309 is an example of any of the examples of gripper 109, 209, 309, 409, 509, 609, 709, 809, 909, 1209, 1309, 1409, 1609, 1709, 1809, 1909, 2009, 2209 shown in FIGS. 1-7, 8, 9, 12, 13A, 14-20 and 22A.

In one or more examples, gripper 2309 includes gripper body 2344. Gripper body 2344 includes receiving end 2343 and locking end 2345, opposite receiving end 2343. Receiving end 2343 includes concave gripper surface 2357 that is configured to surround a portion of container 101 (not shown in FIGS. 23A-23C). Suction cup 2378 is coupled to receiving end 2343 and extends from concave gripper surface 2357.

Vacuum source 2384 is in fluid communication with suction cup 2378, for example, via vacuum supply line 2388 (e.g., as shown in FIG. 23B). In one or more examples, locking end 2345 of gripper body 2344 is coupled to vacuum source 2384. In one or more examples, vacuum source 2384 is coupled to the lug (not shown in FIGS. 23A-23C) by coupling 2347.

In one or more examples, actuator 2356 is coupled to vacuum source 2384. Actuator 2356 drives operation of vacuum source 2384 for generating the vacuum, which is supplied to suction cup 2378.

In one or more examples, receiving end 2343 is removable from gripper body 2344. Removal of receiving end 2343 from gripper body 2344 enables different receiving ends to be interchanged, as needed, such as having a different style or size of suction cup 2378, a different shape of receiving end 2343 or a different contour of concave gripper surface 2357. This allows system 100 to be easily changed for containers 101 with a different diameter or shape.

Referring to FIGS. 23A and 23B, in one or more examples, gripper 2309 includes pneumatic coupling 2397. In one or more examples, pneumatic coupling 2397 is a quick disconnect pneumatic fitting.

Referring to FIG. 23C, in one or more examples, pneumatic coupling 2397 includes first portion 2397a (e.g., a male portion) and second portion 2397b (e.g., female portion). In one or more examples, first portion 2397a of pneumatic coupling 2397 is coupled to receiving end 2343 and is in fluid communication with suction cup 2378. Second portion 2397b of pneumatic coupling 2397 is coupled to gripper body 2344 and is in fluid communication with vacuum source 2384.

In one or more examples, insert 2353 is located on or is coupled (e.g., applied) to at least a portion of concave gripper surface 2357 of receiving end 2343. For example, insert 2353 is located on a portion of concave gripper surface 2357 that surrounds suction cup 2378. Insert 2353 has a coefficient of friction that is greater than a coefficient of friction of concave gripper surface 2357. Insert 2353 provides a contact surface of container 101 contacting receiving end 2343 of gripper body 2344. As such, insert 2353 assists suction cup 2378 in holding container 101 in the desired orientation.

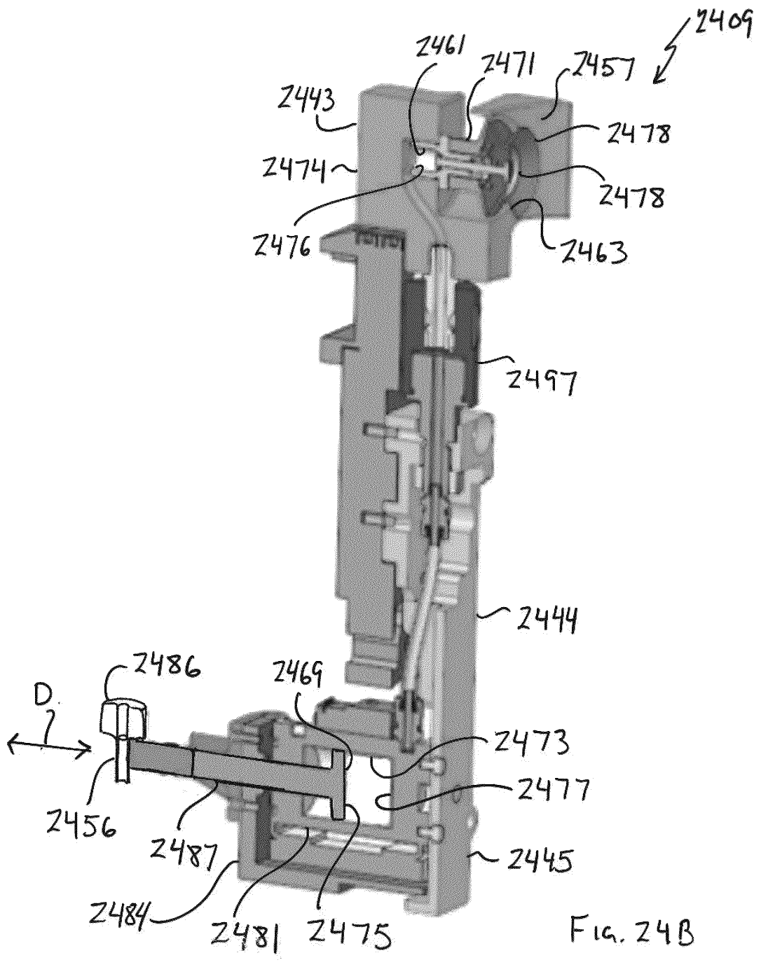

Referring now to FIGS. 24A and 24B, which illustrate an example of gripper 2409. The example of gripper 2409 shown in FIGS. 24A and 24B shares many common features with the examples of gripper 109, 209, 309, 409, 509, 609, 709, 809, 909, 1209, 1309, 1409, 1609, 1709, 1809, 1909, 2009, 2209, 2309 shown in FIGS. 1-7, 8, 9, 12, 13A, 14-20, 22A and 23A-23C. In the example of gripper 2409 shown in FIGS. 24A and 24B, like numerals have, where possible, been used to denote like parts, albeit with the addition of the prefix “2400” to indicate that these features belong to another example of the gripper. In one or more examples, gripper 2409 is an example of any of the examples of gripper 109, 209, 309, 409, 509, 609, 709, 809, 909, 1209, 1309, 1409, 1609, 1709, 1809, 1909, 2009, 2309 shown in FIGS. 1-7, 8, 9, 12, 13A, 14-20, 22A and 23A-23C.

In one or more examples, gripper 2409 includes gripper body 2444. Gripper body 2444 includes receiving end 2443 and locking end 2445, opposite receiving end 2343. Receiving end 2443 includes concave gripper surface 2457 that is configured to surround a portion of container 101 (not shown in FIGS. 24A and 24B). Suction cup 2478 is coupled to receiving end 2443 and extends from concave gripper surface 2457.

Vacuum source 2484 is in fluid communication with suction cup 2478, for example, via vacuum supply line 2488. Receiving end 2443 is coupled to and removable from gripper body 2444, for example, via pneumatic coupling 2497. Actuator 2456 is coupled to and drives operation of vacuum source 2484.

In one or more examples, gripper 2409 includes suction body 2474. Suction body 2474 forms first vacuum cavity 2476. In one or more examples, suction body 2474 is coupled to, is integrated with or is otherwise formed by gripper body 2444. In one or more examples, suction body 2474 is coupled to, is integrated with or is otherwise formed by receiving end 2443 (e.g., as shown in FIGS. 24A and 24B).

In one or more examples, suction body 2474 is in fluid communication with vacuum source 2484, for example, via vacuum supply line 2488. The vacuum (e.g., negative pressure) generated by vacuum source 2484 is supplied to first vacuum cavity 2476, thereby, evacuating gas (e.g., air) from first vacuum cavity 2476 and selectively reducing pressure within first vacuum cavity 2476 of suction body 2474.

In one or more examples, suction cup 2478 is coupled to suction body 2474. Suction cup 2478 forms second vacuum cavity 2482. Second vacuum cavity 2482 of suction cup 2478 is in selective fluid communication with first vacuum cavity 2476 of suction body 2474. With suction cup 2478 in contact with and sealed to the surface of container 101, the vacuum is selectively supplied from first vacuum cavity 2476 to second vacuum cavity 2482 such that container 101 is coupled to suction cup 2478 via vacuum.

In one or more examples, first vacuum cavity 2476 is initially sealed or closed to form first vacuum chamber 2461, which is sealed (e.g., a sealed first vacuum chamber), for application of the vacuum from vacuum source 2484 and reduction of pressure within first vacuum chamber 2461. With suction cup 2478 in contact with and sealed to the surface of container 101, container 101 closes second vacuum cavity 2482 to form second vacuum chamber 2463, which is sealed (e.g., a sealed second vacuum chamber). In other words, suction cup 2478 and container 101 form second vacuum chamber 2463. Subsequently, first vacuum cavity 2476 is selectively configured (e.g., placed) in fluid communication with second vacuum cavity 2482. The vacuum (e.g., negative pressure) within first vacuum cavity 2473 is supplied to second vacuum cavity 2482, thereby, evacuating gas (e.g., air) from second vacuum cavity 2482 and selectively reducing pressure within second vacuum chamber 2463 to hold container 101 in the desired orientation against suction cup 2478.

In one or more examples, gripper 2409 includes valve 2471. Valve 2471 is coupled to suction body 2474 and to suction cup 2478. Valve 2471 is configured to be selectively actuated between a closed position to restrict transfer of the vacuum from first vacuum cavity 2476 to second vacuum cavity 2482 and an open position to supply the vacuum from first vacuum cavity 2476 to second vacuum cavity 2482. In other words, with valve 2471 in the closed position, valve 2471 closes and seals first vacuum cavity 2476 to form first vacuum chamber 2461, thereby, isolating first vacuum cavity 2476 (e.g., first vacuum chamber 2461) from second vacuum cavity 2482 (e.g., second vacuum chamber 2463). With valve 2471 in the open position, first vacuum cavity 2476 (e.g., first vacuum chamber 2461) is configured to be in fluid communication with second vacuum cavity 2482 (e.g., second vacuum chamber 2463).

In one or more examples, valve 2471 is biased in the closed position. In one or more examples, valve 2471 is selectively actuated to the open position in response to flush contact and sealing of suction cup 2478 with the surface of container 101.

Vacuum source 2484 can include or take the form of any suitable device or mechanism configured to or capable of generating the vacuum (e.g., negative pressure). In one or more examples, vacuum source 2484 is or includes a vacuum pump configured to remove air molecules (and other gases) from a vacuum chamber. In one or more examples, vacuum source 2484 is, includes or takes the form of a positive displacement pump configured to create a low or soft vacuum by expanding the volume of a cavity and allowing gases to flow out of a sealed environment or chamber. However, in other examples, vacuum source 2484 can include or take the form of any one of various other types of vacuum pumps.

FIGS. 24A and 24B illustrate an example of vacuum source 2484 as a reciprocating-type or linear-type positive displacement pump. However, in other examples, vacuum source 2484 can be a rotary-type positive displacement pump. In any of these examples, actuator 2456 is configured to drive operation of the positive displacement pump for generation of the vacuum.

In one or more examples, vacuum source 2484 includes drive cylinder 2481 that forms third vacuum cavity 2473 and drive member 2475. Drive member 2475 is situated and closely fit within third vacuum cavity 2473, such that drive member 2475 closes and seals third vacuum cavity 2473 to form third vacuum chamber 2477, which is sealed (e.g., a sealed third vacuum chamber). In other words, drive cylinder 2481 and drive member 2475 form third vacuum chamber 2477. Third vacuum cavity 2473 is in fluid communication with first vacuum cavity 2476 of suction body 2474. Drive member 2475 is linearly movable within third vacuum cavity 2473 and relative to drive cylinder 2481 to expand or retract the volume of third vacuum chamber 2477 and generate the vacuum within third vacuum chamber 2477. Actuator 2456 is coupled to drive member 2475 and is configured to drive selective linear movement of drive member 2475.

FIG. 24A illustrates a first position (e.g., a rest position) of drive member 2475 in which vacuum source 2484 is not generating the vacuum. FIG. 24B illustrates a second position (e.g., an actuated position) of drive member 2475 in which drive member 2475 is linearly moved within drive cylinder 2481 to expand the volume of third vacuum chamber 2477 and generate the vacuum.

In one or more examples, actuator 2456 includes cam follower 2486. Cam follower 2486 is coupled to drive member 2475. For example, vacuum source 2484 includes connecting rod 2487 that is coupled to drive member 2475 and that extends through drive cylinder 2481. Cam follower 2486 is coupled to connecting rod 2487. Cam follower 2486 forms a portion of the cam assembly (e.g., cam assembly 1954 shown in FIG. 19).

Referring now to FIG. 19, in one or more examples, grouping module 1906 includes drive cam 1983. Drive cam 1983 forms a portion of cam assembly 1954. Drive cam 1983 extends along track 1908. Cam follower 1986 is configured to engage drive cam 1983 as gripper 1909 moves along track 1908. Engagement of cam follower 1986 with drive cam 1983 operates vacuum source 1984. In other words, movement of cam follower 1986 by drive cam 1983 actuates vacuum source 1984 and causes vacuum source 1984 to generate the vacuum. For example, cam follower 1986 engages drive cam 1983 to selectively move the drive member (e.g., drive member 2475 shown in FIGS. 24A and 24B) of vacuum source 1984 within the third vacuum cavity (e.g., third vacuum cavity 2473 shown in FIGS. 24A and 24B).

In one or more examples, drive cam 1983 includes or takes the form of a cam track or other cam surface that extends along track 1908. Drive cam 1983 is configured to drive (e.g., linearly move) cam follower 1986 relative to vacuum source 1984 (e.g., in the directions indicated by directional arrow “D” in FIGS. 19, 24A and 24B) as gripper 1909 moves along track 1908 and as cam follower 1986 moves along a cam surface of drive cam 1983. Selective linear movement of cam follower 1986, driven by drive cam 1983, translates to linear movement and selective positioning of the drive member (e.g., drive member 2475 shown in FIGS. 24A and 24B) of vacuum source 1984 within the third vacuum cavity (e.g., third vacuum cavity 2473 shown in FIGS. 24A and 24B) to selectively control the vacuum generated by vacuum source 1984.

Referring again to FIGS. 24A and 24B, in one or more examples, drive member 2475 is or takes the form of piston 2469. For example, vacuum source 2484 is or takes the form of a piston displacement pump.

In one or more examples, movement of cam follower 2486 in a first direction retracts drive member 2475 (e.g., piston 2469), effectively increasing or expanding the volume of third vacuum chamber 2477 to generate the vacuum (e.g., as shown in FIG. 24B). Movement of cam follower 2486 in a second direction, opposite the first direction, extends drive member 2475 (e.g., piston 2469), effectively decreasing or reducing the volume of third vacuum chamber 2477 to reduce or terminate the vacuum (e.g., as shown in FIG. 24A).

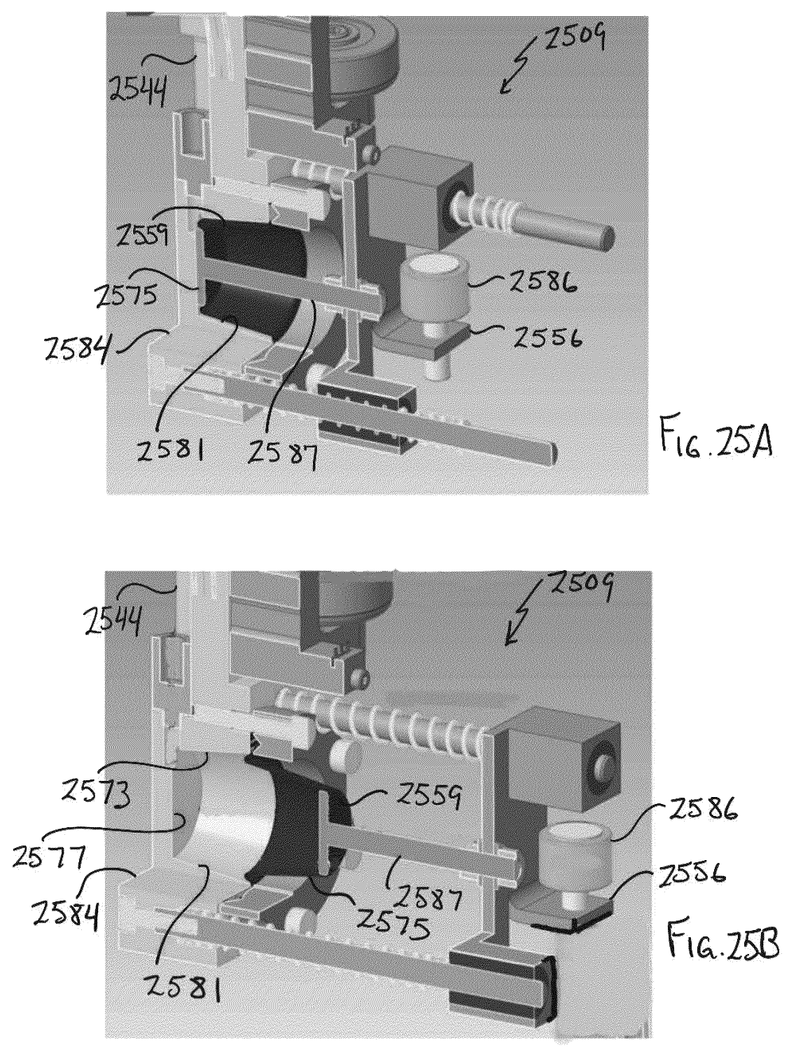

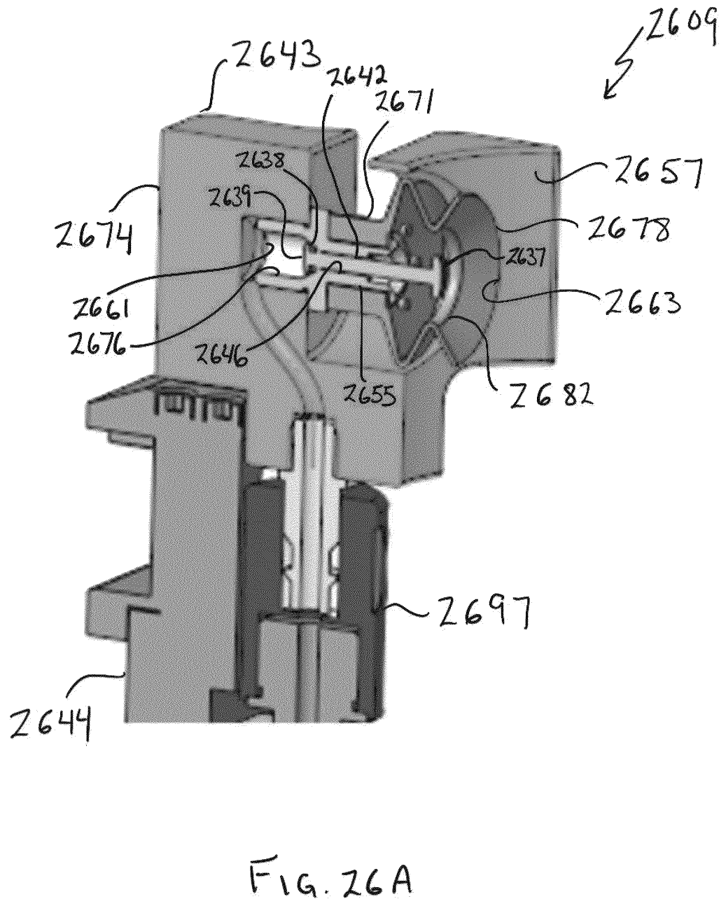

Referring now to FIGS. 25A and 25B, which illustrate an example of a portion of gripper 2509. The example of gripper 2509 shown in FIGS. 25A and 25B shares many common features with the examples of gripper 109, 209, 309, 409, 509, 609, 709, 809, 909, 1209, 1309, 1409, 1609, 1709, 1809, 1909, 2009, 2209, 2309, 2409 shown in FIGS. 1-7, 8, 9, 12, 13A, 14-20, 22A, 23A-23C, 24A and 24B. In the example of gripper 2509 shown in FIGS. 25A and 25B, like numerals have, where possible, been used to denote like parts, albeit with the addition of the prefix “2500” to indicate that these features belong to another example of the gripper. In one or more examples, gripper 2509 is an example of any of the examples of gripper 109, 209, 309, 409, 509, 609, 709, 809, 909, 1209, 1309, 1409, 1609, 1709, 1809, 1909, 2009, 2309 shown in FIGS. 1-7, 8, 9, 12, 13A, 14-20, 22A and 23A-23C.

In particular, FIGS. 25A and 25B illustrate an example of vacuum source 2584 of gripper 2509. FIGS. 25A and 25B illustrate an example of vacuum source 2584 as a reciprocating-type or linear-type positive displacement pump. FIG. 25A illustrates a first position (e.g., a rest position) of drive member 2575 in which vacuum source 2584 is not generating the vacuum. FIG. 25B illustrates a second position (e.g., an actuated position) of drive member 2575 in which drive member 2575 is moved within drive cylinder 2581 to expand the volume of third vacuum chamber 2577 and generate the vacuum.

In one or more examples, vacuum source 2584 includes drive cylinder 2581 that forms third vacuum cavity 2573 and drive member 2575. Drive member 2575 is situated and closely fit within third vacuum cavity 2573, such that drive member 2575 closes and seals third vacuum cavity 2573 to form third vacuum chamber 2577, which is sealed (e.g., a sealed third vacuum chamber). In other words, drive cylinder 2581 and drive member 2575 form third vacuum chamber 2577. Third vacuum cavity 2573 is in fluid communication with the first vacuum cavity of the suction body (not shown in FIGS. 25A and 25B) of gripper 2509. Drive member 2575 is linearly movable within third vacuum cavity 2573 and relative to drive cylinder 2581 to expand or retract the volume of third vacuum chamber 2577 and generate the vacuum within third vacuum chamber 2577. Actuator 2556 is coupled to drive member 2575 and is configured to drive selective linear movement of drive member 2575.

In one or more examples, actuator 2556 includes cam follower 2586. Cam follower 2586 is coupled to drive member 2575. For example, vacuum source 2584 includes connecting rod 2587 that is coupled to drive member 2575. Cam follower 2586 is coupled to connecting rod 2587. Cam follower 2586 is configured to engage the drive cam (e.g., drive cam 1983 shown in FIG. 19) as gripper 2509 moves along the track (e.g., track 1908 shown in FIG. 19).

In one or more examples, the drive cam (not shown in FIGS. 25A and 25B) is configured to drive (e.g., linearly move) cam follower 2586 relative to vacuum source 2584 (e.g., in the directions indicated by directional arrow “D” in FIGS. 19, 25A and 25B) as gripper 2509 moves along the track (not shown in FIGS. 25A and 25B) and as cam follower 2586 moves along a cam surface of the drive cam. Selective linear movement of cam follower 2586, driven by the drive cam, translates to linear movement and selective positioning of drive member 2574 of vacuum source 2584 within third vacuum cavity 2573 to selectively control the vacuum generated by vacuum source 2584.

In one or more examples, drive member 2575 is or takes the form of diaphragm 2559. For example, vacuum source 2584 is or takes the form of a diaphragm displacement pump.

In one or more examples, movement of cam follower 2586 in a first direction expands drive member 2575 (e.g., diaphragm 2559), effectively increasing or expanding the volume of third vacuum chamber 2477 to generate the vacuum (e.g., as shown in FIG. 25B). Movement of cam follower 2586 in a second direction, opposite the first direction, collapses or constricts drive member 2475 (e.g., diaphragm 2559), effectively decreasing or reducing the volume of third vacuum chamber 2577 to reduce or terminate the vacuum (e.g., as shown in FIG. 25A).

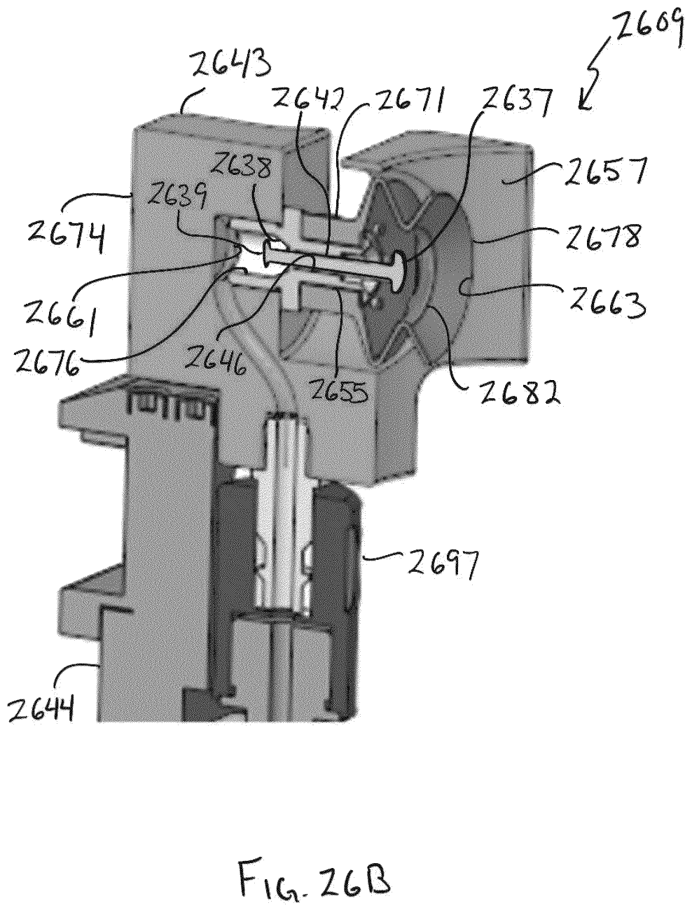

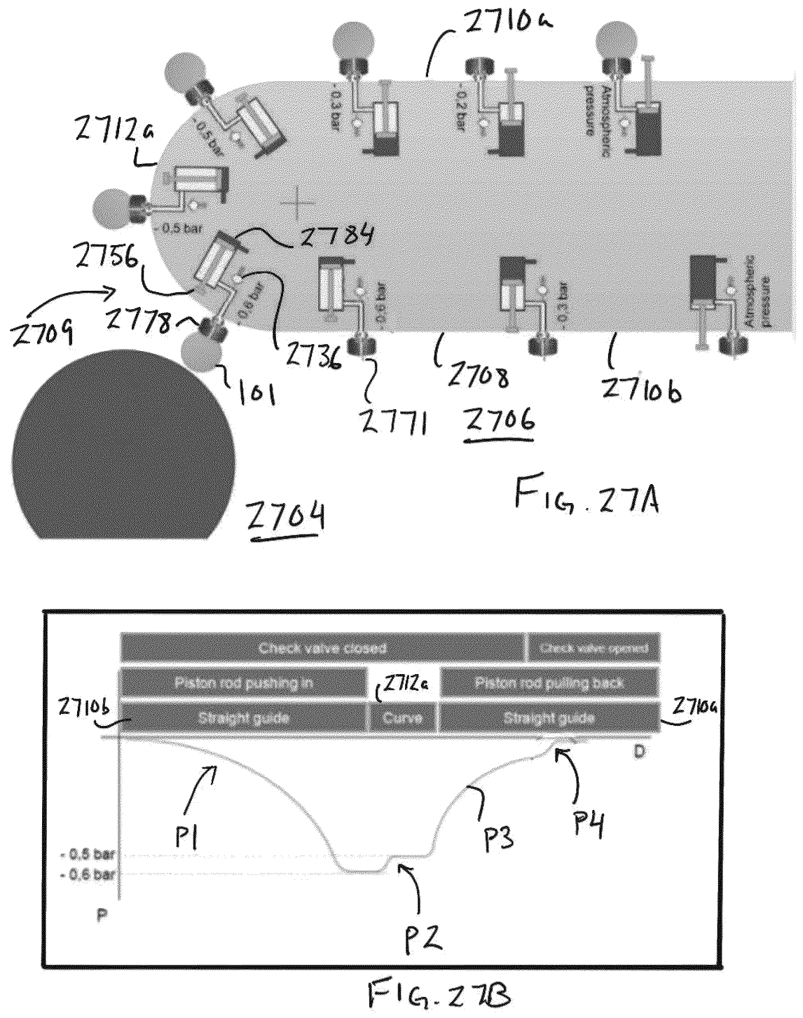

Referring now to FIGS. 26A and 26B, which illustrate an example of a portion of gripper 2609. The example of gripper 2609 shown in FIGS. 26A and 26B shares many common features with the examples of gripper 109, 209, 309, 409, 509, 609, 709, 809, 909, 1209, 1309, 1409, 1609, 1709, 1809, 1909, 2009, 2209, 2309, 2409, 2509 shown in FIGS. 1-7, 8, 9, 12, 13A, 14-20, 22A, 23A-23C, 24A, 24B, 25A and 25B. In the example of gripper 2609 shown in FIGS. 26A and 26B, like numerals have, where possible, been used to denote like parts, albeit with the addition of the prefix “2600” to indicate that these features belong to another example of the gripper. In one or more examples, gripper 2609 is an example of any of the examples of gripper 109, 209, 309, 409, 509, 609, 709, 809, 909, 1209, 1309, 1409, 1609, 1709, 1809, 1909, 2009, 2309, 2409, 2509 shown in FIGS. 1-7, 8, 9, 12, 13A, 14-20, 22A, 23A-23C, 24A, 24B, 25A and 25B.

In particular, FIGS. 26A and 26B illustrate an example of valve 2671 of gripper 2609 (e.g., as previously depicted in the example of valve 2471 shown in FIGS. 24A and 24B). Valve 2671 is coupled to suction body 2674 and to suction cup 2678. Valve 2671 is configured to be selectively actuated between a closed position to restrict transfer of the vacuum from first vacuum cavity 2676 to second vacuum cavity 2682 and an open position to supply the vacuum from first vacuum cavity 2676 to second vacuum cavity 2682. In other words, valve 2671 is a vacuum control valve configured to control the supply of vacuum from first vacuum chamber 2461 to second vacuum chamber 2463, effectively removing air from the space within second vacuum chamber 2463 and controlling (e.g., reducing) the pressure in second vacuum chamber 2463. With valve 2671 in the closed position, valve 2671 closes and seals first vacuum cavity 2676 to form first vacuum chamber 2661, thereby, isolating first vacuum cavity 2676 from second vacuum cavity 2682 (e.g., as shown in FIG. 26A). With valve 2671 in the open position, first vacuum cavity 2676 is configured to be in fluid communication with second vacuum cavity 2682.

In one or more examples, valve 2671 includes valve body 2655. Valve body 2655 is coupled to (e.g., between) suction body 2674 and suction cup 2678. Valve body 2655 forms valve port 2646. Valve port 2646 is in selective fluid communication with first vacuum cavity 2576 and second vacuum cavity 2582 and is configured to enable the vacuum to pass from with first vacuum cavity 2576 to second vacuum cavity 2582, through valve body 2655. Valve 2671 also includes valve stem 2642 that is situated within valve port 2646 and is configured to move relative to valve body 2655. Valve disk 2639 is coupled to an end of valve stem 2642 and is situated within valve seat 2638 of valve body 2655. Movement of valve stem 2642 translates to movement of valve disk 2639 relative to valve seat 2638 to selectively contact valve seat 2638 and selectively restrict flow of the vacuum through valve port 2646 (e.g., to open or close valve port 2646). Valve feeler 2637 is coupled to another end of valve stem 2642, opposite valve disk 2639. Valve feeler 2637 is situated within second vacuum cavity 2582 (e.g., within suction cup 2578). Valve feeler 2637 is configured to contact container 101 when suction cup 2678 mates with container 101.

In one or more examples, valve 2671 is biased in the closed position (e.g., as shown in FIG. 26A). For examples, valve 2671 includes a biasing member (not shown), such as a spring, that is situated around or is coupled to valve stem 2642 to bias valve stem 2642 in a position that places valve disk 2639 in contact with valve seat 2638, effectively restricting fluid flow through valve port 2646.

In one or more examples, valve 2571 is selectively actuated to the open position (e.g., as shown in FIG. 26B) in response to flush contact and sealing of suction cup 2578 with the surface of container 101. For example, during handoff of container 101 (not shown in FIGS. 26A and 26B) from the orienting module (not shown in FIGS. 26A and 26B) to gripper 2609, suction cup 2578 is moved into flush contact with container 101 such that a seal is formed between suction cup 2578 and the surface of container 101, effectively forming second vacuum chamber 2563, as gripper 2609 moves along the track (not shown in FIGS. 26A and 26B). As suction cup 2578 is compressed during contact with container 101, container 101 contacts valve feeler 2673 and applies an actuation force to valve feeler 2673 to move (e.g., push) valve stem 2642, thus, unseating valve disk 2639 from valve seat 2638, effectively opening valve 2571 and enabling transfer of the vacuum from first vacuum chamber 2561 to second vacuum chamber 2563.

Referring to FIG. 27A, which illustrates an example of a portion of system 100. The example of system 100 shown in FIG. 27A shares many common features with the examples of system 100 shown in FIGS. 1-7, 8, 9 and 10-19. In the example of system 100 shown in FIG. 27A, like numerals have, where possible, been used to denote like parts, albeit with the addition of the prefix “2700” to indicate that these features belong to another example of system 100.

FIG. 27A depicts grippers 2709 moving container 101 along track 2708 and, more particularly, grippers 2109 moving containers 101 along first curved section 2712a of track 2708 in which the centrifugal force acting upon containers 101 urges containers 101 to rotate to a non-desired orientation. In one or more examples, gripper 2709 is configured to selectively control the vacuum pressure applied to container 101 as gripper 2709 moves container 101 along track 2708. In one or more examples, gripper 2709 is configured to vary the vacuum pressure applied to container 101 as gripper 2709 moves container 101 along first curved section 2712a of track 2708.

FIG. 27B illustrates a graphical representation of a pressure profile for the vacuum applied to container 101 by gripper 2709, as gripper 2709 moves along a portion of track 2708 (as shown in FIG. 27A). In the examples illustrated in FIGS. 27A and 27B, the reference pressure is atmospheric air pressure (e.g., approximately 1 bar).

Referring to FIGS. 27A and 27B, in one or more examples, generally, vacuum is initially generated by actuating vacuum source 2784 (e.g., the pneumatic cylinder) using actuator 2756 on the sealed pneumatic circuit (e.g., as shown at P1 in FIG. 27B). Then, the vacuum is opened on (e.g., supplied to) suction cup 2778, for example, via contact of container 101 with suction cup 2778 to actuate valve 2771 to the open position (e.g., as shown at P2 in FIG. 27B). If the circuit pressure is greater than or equal to zero when vacuum source 2784 is reset (e.g., when the drive member of the pneumatic piston is not completely moved back to an initial position) and there is no container 101 coupled to or in contact with suction cup 2778 (e.g., as shown at P3 in FIG. 27C), then check valve 2736 automatically evacuates surplus air, thereby resetting the circuit pressure back to approximately zero (e.g., as shown at P4 in FIG. 27B).

In one or more examples, gripper 2709 does not generate the vacuum along a portion second straight section 2710b of track 2708 (e.g., the vacuum pressure is approximately 0.0 bar (e.g., atmospheric pressure)).

As gripper 2709 moves toward first curved section 2712a of track 2708, gripper 2709 (e.g., vacuum source 2784) generates the vacuum having a vacuum pressure of approximately −0.3 bar. In one or more examples, the vacuum is supplied to (e.g., pressure is reduced within) the first vacuum chamber (not shown in FIG. 27A) of gripper 2709.

As gripper 2709 moves further toward first curved section 2712a of track 2708, gripper 2709 (e.g., vacuum source 2784) increases the vacuum to a vacuum pressure of approximately −0.6 bar. In one or more examples, the vacuum is increased within (e.g., pressure is further reduced within) the first vacuum chamber (not shown in FIG. 27A) of gripper 2709.

As gripper 2709 begins to move along first curved section 2712a and approaches orienting module 2704, suction cup 2778 contacts container 101 and container 101 is handed off to gripper 2709. Upon contact and sealing of suction cup 2778 with container 101, container 101 actuates the valve 2771 of gripper 2709 to supply the vacuum from the first vacuum chamber (not shown in FIG. 27A) to the second vacuum chamber (not shown in FIG. 27A) of gripper 2709, effectively reducing pressure within the second vacuum chamber (e.g., between suction cup 2778 and container 101). For example, and as illustrated in FIGS. 26A and 26B, container 101 contacts valve feeler 2637 of valve 2671 to actuate valve 2671 from the closed position (e.g., as shown in FIG. 26A) to the open position (e.g., as shown in FIG. 26B).

It can be appreciated that transfer of the vacuum from the first vacuum chamber (not shown in FIG. 27A) to the second vacuum chamber (not shown in FIG. 27A) of gripper 2709 may result in a small loss of vacuum pressure (e.g., from approximately −0.6 bar to approximately −0.5 bar as shown in FIGS. 27A and 27B). Accordingly, in one or more examples, gripper 2709 (e.g., vacuum source 2784) is configured to generate an excess of vacuum pressure (e.g., stored in the first vacuum chamber) to account for any loss during transfer of the vacuum from the first vacuum chamber to the second vacuum chamber during actuation of the valve and vacuum coupling of suction cup 2778 with container 101, such that the vacuum applied to container 101 is sufficient to maintain container 101 in the desired orientation.

The vacuum pressure of −0.5 bar is maintained as gripper 2709 moves container 101 along first curved section 2712a of track 2708. Afterwards (e.g., at a location along first straight section 2710a of track 2108), the vacuum is progressively decreased and eventually ceased (e.g., the pressure raises back to 0.0 bar) such that gripper 2709 can peel away from container 101 without shifting, turning, or otherwise disturbing container 101. At this point, if the vacuum pressure is greater than or equal to zero, check valve 2736 automatically evacuates surplus air, thereby resetting the vacuum pressure back to approximately zero (e.g., atmospheric pressure).

The vacuum pressure generated by gripper 2709 (e.g., by vacuum source 2784) is selectively controlled (e.g., varied as gripper 2709 moves along track 2708) using actuator 2756, as described herein above. The ranges of vacuum pressure are provided merely as examples and other values of vacuum pressure may be implemented without departing from the intended structure and operation of gripper 2709 and without departing from the principles of the present disclosure and purpose of system 100.

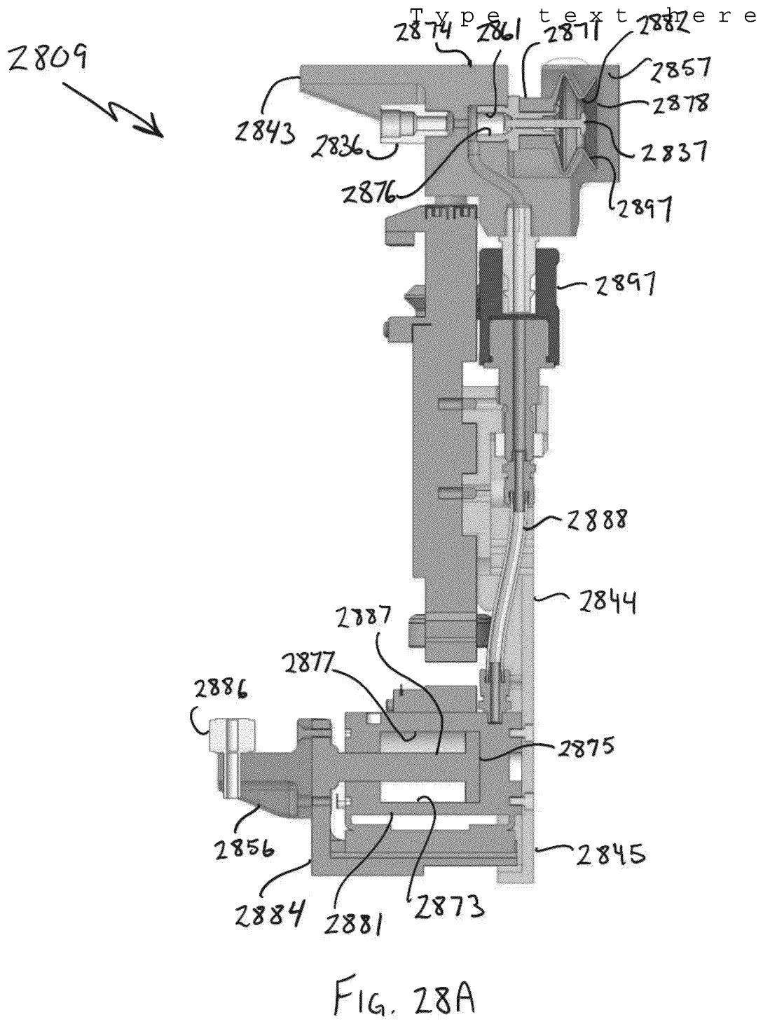

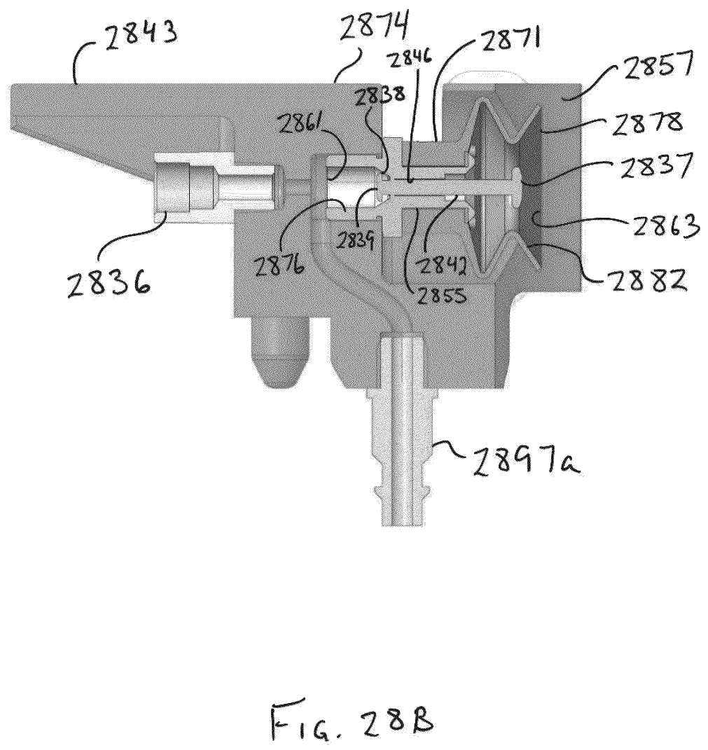

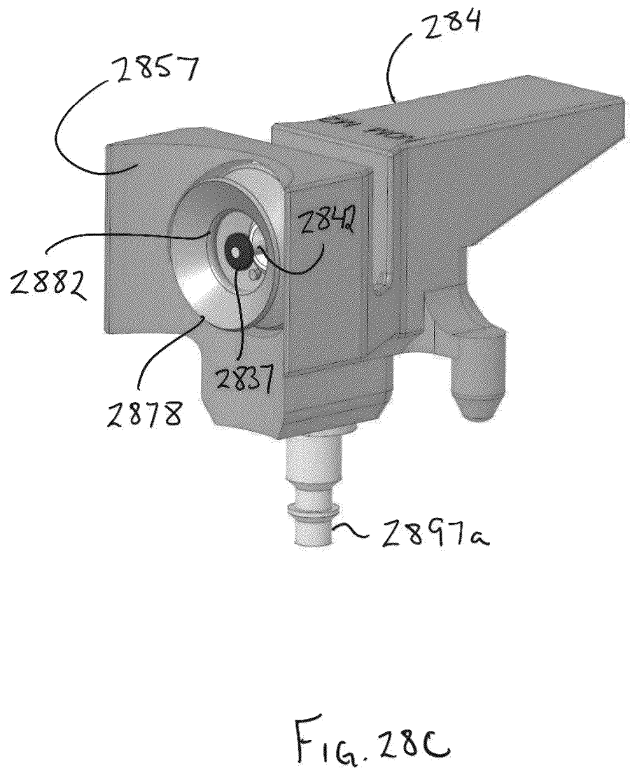

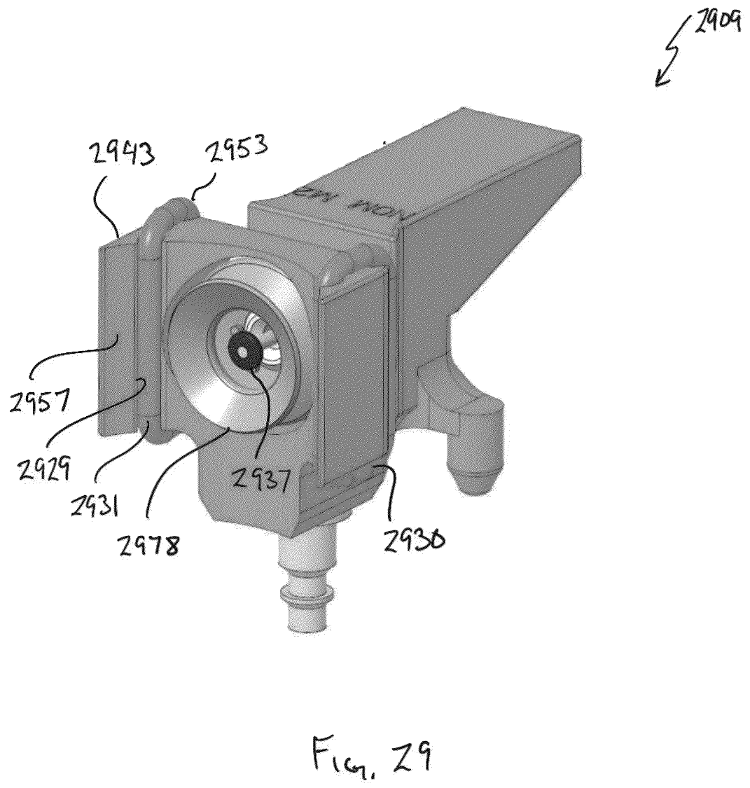

Referring now to FIGS. 28A-28C, which illustrates an example of gripper 2809. The example of gripper 2809 shown in FIGS. 28A-28C shares many common features with the examples of gripper 109, 209, 309, 409, 509, 609, 709, 809, 909, 1209, 1309, 1409, 1609, 1709, 1809, 1909, 2009, 2209, 2309, 2409, 2609, 2709 shown in FIGS. 1-7, 8, 9, 12, 13A, 14-20, 22A, 23A-23C, 24A, 24B, 26A, 26B and 27A. In the example of gripper 2809 shown in FIGS. 28A-28C, like numerals have, where possible, been used to denote like parts, albeit with the addition of the prefix “2800” to indicate that these features belong to another example of the gripper. In one or more examples, gripper 2809 is an example of any of the examples of gripper 109, 209, 309, 409, 509, 609, 709, 809, 909, 1209, 1309, 1409, 1609, 1709, 1809, 1909, 2009, 2309, 2709 shown in FIGS. 1-7, 8, 9, 12, 13A, 14-20, 22A, 23A-23C and 27A.

Referring to FIG. 28A, in one or more examples, gripper 2809 includes gripper body 2844. Gripper body 2844 includes receiving end 2843 and locking end 2845, opposite receiving end 2843. Receiving end 2843 includes concave gripper surface 2857 that is configured to surround a portion of container 101 (not shown). Suction cup 2878 is coupled to receiving end 2843 and, for example, extends from concave gripper surface 2857.

Vacuum source 2884 is in fluid communication with suction cup 2878, for example, via vacuum supply line 2888. Receiving end 2843 is coupled to and removable from gripper body 2844, for example, via pneumatic coupling 2897. Actuator 2856 is coupled to and drives operation of vacuum source 2884.

In one or more examples, gripper 2809 includes suction body 2874. Suction body 2874 forms first vacuum cavity 2876. In one or more examples, suction body 2874 is coupled to, is integrated with or is otherwise formed by gripper body 2844. In one or more examples, suction body 2874 is coupled to, is integrated with or is otherwise formed by receiving end 2843.

In one or more examples, suction body 2874 is in fluid communication with vacuum source 2884, for example, via vacuum supply line 2888. The vacuum (e.g., negative pressure) generated by vacuum source 2884 is supplied to first vacuum cavity 2876, thereby, evacuating gas (e.g., air) from first vacuum cavity 2876 and selectively reducing pressure within first vacuum cavity 2876 of suction body 2874.

In one or more examples, suction cup 2878 is coupled to suction body 2874. Suction cup 2878 forms second vacuum cavity 2882. Second vacuum cavity 2882 of suction cup 2878 is in selective fluid communication with first vacuum cavity 2876 of suction body 2874. With suction cup 2878 in contact with and sealed to the surface of container 101, the vacuum is selectively supplied from first vacuum cavity 2876 to second vacuum cavity 2882 via valve 2871 such that container 101 is coupled to suction cup 2878 via vacuum.

In one or more examples, first vacuum cavity 2876 is initially sealed or closed to form first vacuum chamber 2861, which is sealed (e.g., a sealed first vacuum chamber), for application of the vacuum from vacuum source 2884 and reduction of pressure within first vacuum chamber 2861. With suction cup 2878 in contact with and sealed to the surface of container 101, container 101 closes second vacuum cavity 2882 to form second vacuum chamber 2863, which is sealed (e.g., a sealed second vacuum chamber). In other words, suction cup 2878 and container 101 form second vacuum chamber 2863. Subsequently, first vacuum cavity 2876 is selectively configured (e.g., placed) in fluid communication with second vacuum cavity 2882, for example, via valve 2871. The vacuum (e.g., negative pressure) within first vacuum cavity 2873 is supplied to second vacuum cavity 2882, thereby, evacuating gas (e.g., air) from second vacuum cavity 2482 and selectively reducing pressure within second vacuum chamber 2863 to hold container 101 in the desired orientation against suction cup 2878.

In one or more examples, valve 2871 is coupled to suction body 2874 and to suction cup 2878. Valve 2871 is configured to be selectively actuated between a closed position to restrict transfer of the vacuum from first vacuum cavity 2876 to second vacuum cavity 2882 and an open position to supply the vacuum from first vacuum cavity 2876 to second vacuum cavity 2882. In other words, with valve 2871 in the closed position, valve 2871 closes and seals first vacuum cavity 2876 to form first vacuum chamber 2861, thereby, isolating first vacuum cavity 2876 (e.g., first vacuum chamber 2861) from second vacuum cavity 2882 (e.g., second vacuum chamber 2863). With valve 2871 in the open position, first vacuum cavity 2876 (e.g., first vacuum chamber 2861) is configured to be in fluid communication with second vacuum cavity 2882 (e.g., second vacuum chamber 2863).

In one or more examples, valve 2871 is biased in the closed position. In one or more examples, valve 2871 is selectively actuated to the open position in response to flush contact and sealing of suction cup 2878 with the surface of container 101.

Referring briefly to FIG. 28B, in one or more examples, valve 2871 includes valve body 2855. Valve body 2855 is coupled to (e.g., between) suction body 2874 and suction cup 2878. Valve body 2855 forms valve port 2846. Valve port 2846 is in selective fluid communication with first vacuum cavity 2876 and second vacuum cavity 2882 and is configured to enable the vacuum to pass from with first vacuum cavity 2876 to second vacuum cavity 2882, through valve body 2855. Valve 2871 also includes valve stem 2642 that is situated within valve port 2846 and is configured to move relative to valve body 2855. Valve disk 2839 is coupled to an end of valve stem 2842 and is situated within valve seat 2838 of valve body 2855. Movement of valve stem 2842 translates to movement of valve disk 2839 relative to valve seat 2838 to selectively contact valve seat 2838 and selectively restrict flow of the vacuum through valve port 2846 (e.g., to open or close valve port 2846). Valve feeler 2837 is coupled to another end of valve stem 2842, opposite valve disk 2839. Valve feeler 2837 is situated within second vacuum cavity 2882 (e.g., within suction cup 2878). Valve feeler 2837 is configured to contact container 101 when suction cup 2878 mates with container 101.

Referring briefly to FIG. 28C, in one or more examples, valve stem 2842 extends into second vacuum cavity 2882 formed by suction cup 2878 such that valve feeler 2837 is situated at an approximate center of suction cup 2878 and proximate to an open end of suction cup 2878. In this manner, valve feeler 2837 is appropriately located to contact a surface of container 101 (not shown) when suction cup 2878 contacts the surface of container 101 and is initially compressed to create a seal between suction cup 2878 and container 101. Contact between container 101 and valve feeler 2837 moves valve stem 2842 to move valve disk 2839 relative to valve seat 2838 (e.g., as shown in FIG. 28B), thereby actuating valve 2871 in the open position.

Referring again to FIG. 28A, in one or more examples, vacuum source 2884 includes drive cylinder 2881 that forms third vacuum cavity 2873 and drive member 2875. Drive member 2875 is situated and closely fit within third vacuum cavity 2873, such that drive member 2875 closes and seals third vacuum cavity 2873 to form third vacuum chamber 2877, which is sealed (e.g., a sealed third vacuum chamber). Third vacuum cavity 2873 is in fluid communication with first vacuum cavity 2876 of suction body 2874. Drive member 2875 is linearly movable within third vacuum cavity 2873 and relative to drive cylinder 2881 to expand or retract the volume of third vacuum chamber 2877 and generate the vacuum within third vacuum chamber 2877. Actuator 2856 is coupled to drive member 2875 and is configured to drive selective linear movement of drive member 2875.

In one or more examples, actuator 2856 includes cam follower 2886. Cam follower 2886 is coupled to drive member 2875. For example, vacuum source 2884 includes connecting rod 2887 that is coupled to drive member 2875 and that extends through drive cylinder 2881. Cam follower 2886 is coupled to connecting rod 2887. Cam follower 2886 forms a portion of the cam assembly (e.g., cam assembly 1954 shown in FIG. 19). Cam follower 2886 is configured to engage the drive cam (e.g., drive cam 1983 shown in FIG. 19) as gripper 2809 moves along the track (e.g., track 1908 shown in FIG. 19).

Referring to FIGS. 28A and 28B, in one or more examples, gripper 2809 includes check valve 2836. Check valve 2836 is configured to be selectively actuated between a closed position and an open position. In the closed position, check valve 2836 forms a closed pneumatic circuit, for example, between vacuum source 2884 and suction cup 2878. In the open position, check valve 2836 selectively opens the pneumatic circuit. For example, check valve 2836 operates to evacuate surplus pressure in the pneumatic circuit to reset the circuit pressure (e.g., back to approximately zero or atmospheric pressure).

In one or more examples, check valve 2836 is coupled to suction body 2874 and is in selective fluid communication with first vacuum cavity 2876. In the closed position, check valve 2836 seals first vacuum cavity 2876. In other words, in the closed position, check valve 2836 forms a portion of sealed first vacuum chamber 2861. In the open position, check valve 2836 selectively opens the first vacuum cavity 2876. For example, check valve 2836 operates to evacuate surplus pressure in first vacuum cavity 2876 to reset pressure in gripper 2809 (e.g., back to approximately zero or atmospheric pressure).

Referring now to FIG. 29, which illustrates an example of a portion of gripper 2909. The example of gripper 2909 shown in FIG. 29 shares many common features with the examples of gripper 109, 209, 309, 409, 509, 609, 709, 809, 909, 1209, 1309, 1409, 1609, 1709, 1809, 1909, 2009, 2209, 2309, 2409, 2609, 2709, 2809 shown in FIGS. 1-7, 8, 9, 12, 13A, 14-20, 22A, 23A-23C, 24A, 24B, 26A, 26B, 27A and 28A-28C. In the example of gripper 2909 shown in FIG. 29, like numerals have, where possible, been used to denote like parts, albeit with the addition of the prefix “2900” to indicate that these features belong to another example of the gripper. In one or more examples, gripper 2809 is an example of any of the examples of gripper 109, 209, 309, 409, 509, 609, 709, 809, 909, 1209, 1309, 1409, 1609, 1709, 1809, 1909, 2009, 2309, 2409, 2609, 2709, 2809 shown in FIGS. 1-7, 8, 9, 12, 13A, 14-20, 22A, 23A-23C, 24A, 24B, 26A, 26B, 27A and 28A-28C.

In one or more examples, gripper 2909 includes insert 2953. Insert 2953 is placed on or is positioned over at least a portion of a concave portion of receiving end 2943 (e.g., concave gripper surface 1657), such that, when insert 2953 comes in contact with container 101, insert 1653 of receiving end 1643 helps keep container 101 oriented in the proper position and/or orientation.

In one or more examples, insert 2953 includes or takes the form of strips 2931. Strips 2931 are coupled to and protrude from concave gripper surface 2957. In an example, insert 2953 includes two strips 2931, one strip 2931 located on each opposing side of suction cup 2978. In one or more examples, each strip 2931 extends across concave gripper surface 2957 in a direction that is approximately parallel with a longitudinal axis of container 101 (not shown in FIG. 29).

Strips 2931 are made of a material that has a higher coefficient of friction than concave gripper surface 2957. In one or more examples, strips 2931 are made of rubber. In one or more examples, strips 2931 are made of silicone. Other suitable materials for the strips 2931 are also contemplated.

In one or more examples, gripper 2909 includes grooves 2029. Grooves 2029 are formed in or depend inwardly from concave gripper surface 2957. A portion of each one of strips 2931 is situated in and/or is otherwise secured in an associated one of grooves 2029.

Strips 2931 can have any suitable cross-sectional geometry, such as, but not limited to, circular, square, and the like. In one or more examples, each one of strips 2931 is formed by a bead of material coupled or applied to concave gripper surface 2957 (e.g., within an associated groove 2929) and having a higher coefficient of friction than concave gripper surface 2957

In one or more examples, each one of strips 2931 is formed by a portion of O-ring 2030 (e.g., a rubber O-ring, a silicone O-ring, or the like) that is situated around a concave portion of receiving end 2943 such that the portion of O-ring 2030 extends across concave gripper surface 2957 (e.g., in an associated groove 2929).

In other examples, insert 2963 can have other configurations, shapes, and/or sizes suitable for maintaining the desired orientation of container 101.

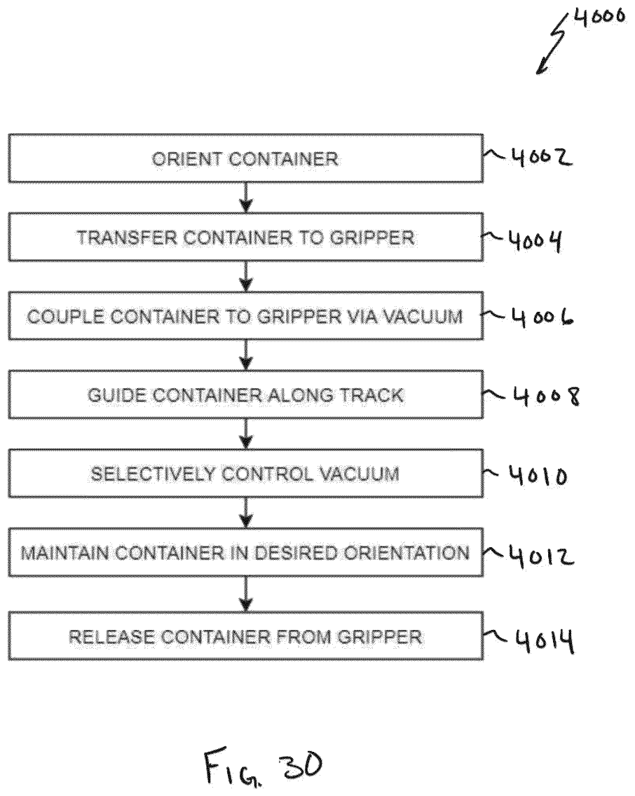

Referring generally to FIGS. 1-29 and particularly to FIG. 30, by way of examples, the present disclosure directed to method 4000 for packaging containers 101 and, more particularly, for holding containers 101 in a desired orientation during packaging. Additionally, examples of method 4000 enable packing and orienting containers 101 for creating packages of containers 101. More particularly, examples of method 4000 facilitate metering of a stream of containers 101, orienting each one of containers 101 is a desired orientation and maintaining the desired orientation throughout a packaging process.

Referring to FIG. 30, in one or more examples, method 4000 includes a step of (block 4002) orienting container 101 in the desired orientation. In one or more examples, container 101 is oriented in the desired orientation using the orienting module.

In one or more examples, method 4000 includes a step of (block 4004) transferring container 101 to the gripper as the gripper moves along the track.

In one or more examples, method 4000 includes a step of (block 4006) coupling container 101 to the gripper via the vacuum.

In one or more examples, the step of coupling container 101 to the gripper via the vacuum includes a step of generating the vacuum in the first vacuum cavity formed by the suction body of the gripper to generate the vacuum. The step of coupling container 101 to the gripper via the vacuum also includes a step of positioning the suction cup of the gripper in contact with container 101. The step of coupling container 101 to the gripper via the vacuum further includes a step of supplying the vacuum to the second vacuum cavity formed by the suction cup.

In one or more examples, the step of supplying the vacuum to the second vacuum cavity formed by the suction cup includes a step of actuating the valve of the gripper, which is coupled to the suction body and the suction cup, from the closed position to the open position in response to contact of the suction cup with container 101.

In one or more examples, method 4000 includes a step of (block 4008) guiding (e.g., conveying) container 101 (e.g., one of a steam of containers) along a portion of the track using the grippers.

In one or more examples, method 4000 includes a step of (block 4010) selectively controlling the vacuum as the gripper moves along the track.

In one or more examples, the step of selectively controlling the vacuum includes a step of moving the cam follower of the gripper along the drive cam as the gripper moves along the track. The step of selectively controlling the vacuum also includes a step selectively moving the drive member situated within the third vacuum chamber and coupled to the cam follower to generate the vacuum within the third vacuum cavity of the vacuum source.

In one or more examples, method 4000 includes a step of (block 4012) maintaining the desired orientation of container 101 using the gripper.

In one or more examples, method 4000 includes a step of (block 4014) releasing container from the gripper.

The preceding detailed description refers to the accompanying drawings, which illustrate specific examples of the disclosed system, gripper and method described by the present disclosure. It will be understood that the disclosed examples are merely exemplary embodiments of the way in which certain aspects of the of the disclosed system, gripper and method can be implemented and do not represent an exhaustive list of all of the ways the of the disclosed system, gripper and method may be embodied. Other examples having different structures and operations do not depart from the scope of the present disclosure.

Well-known components, materials or methods are not necessarily described in detail in order to avoid obscuring the present disclosure. Any specific structural and functional details disclosed herein are not meant to be interpreted as limiting, but merely as a basis for the claims and as a representative basis for teaching one skilled in the art to variously employ the invention.

Like reference numerals may refer to the same feature, element, or component in the different drawings. The figures are not necessarily to scale and some features may be exaggerated or minimized to show details of particular components.

Throughout the present disclosure, any one of a plurality of items may be referred to individually as the item and a plurality of items may be referred to collectively as the items. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

Conditional language such as, among others, “can” or “may,” unless specifically stated otherwise, are otherwise understood within the context as used in general to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Those skilled in the art will appreciate that not all elements described and illustrated in FIGS. 1-30 need be included in every example and not all elements described herein are necessarily depicted in each illustrative example. FIGS. 1-30, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-30, referred to above, need be included in every example and not all elements, features, and/or components described herein are necessarily depicted in each illustrative example. Accordingly, some of the elements, features, and/or components described and illustrated in FIGS. 1-30 may be combined in various ways without the need to include other features described and illustrated in FIGS. 1-30, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-30, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-30, and such elements, features, and/or components may not be discussed in detail herein with reference to each of FIGS. 1-30. Similarly, all elements, features, and/or components may not be labeled in each of FIGS. 1-30, but reference numerals associated therewith may be utilized herein for consistency.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system, flap folding mechanism and method have been shown and described, modifications may occur to those skilled in the art upon reading the specification. The present application includes such modifications and is limited only by the scope of the claims.

What is claimed is:

1. A gripper comprising:
a suction body forming a first vacuum cavity; and
a suction cup coupled to the suction body and forming a second vacuum cavity,
wherein the second vacuum cavity of the suction cup is in selective fluid communication with the first vacuum cavity of the suction body.

2. The gripper of claim 1, further comprising a valve coupled to the suction body and to the suction cup, wherein the valve is configured to be selectively actuated between a closed position to restrict vacuum from the first vacuum cavity to the second vacuum cavity and an open position to supply the vacuum from the first vacuum cavity to the second vacuum cavity.

3. The gripper of claim 2, wherein the valve is biased in the closed position.

4. The gripper of claim 1, further comprising a vacuum source configured to supply vacuum to the first vacuum cavity of the suction body.

5. The gripper of claim 4, further comprising an actuator coupled to the vacuum source and configured to drive the vacuum source.

6. The gripper of claim 5, wherein:
the vacuum source comprises a third vacuum cavity and a drive member situated within and movable relative to the third vacuum cavity; and
the actuator comprises a cam follower coupled to the drive member, wherein the cam follower is configured to engage a drive cam to selectively move the drive member within the third vacuum cavity.

7. The gripper of claim 1, wherein the suction cup is flexible and comprises bellows.

8. The gripper of claim 1, further comprising a gripper body comprising a receiving end and a locking end, opposite the receiving end, wherein:
the receiving end comprises a concave gripper surface; and
the suction cup extends from the concave gripper surface.

9. The gripper of claim 8, further comprising an insert coupled to the concave gripper surface, wherein the insert has a coefficient of friction that is greater than the concave gripper surface, the insert provides a contact surface of a container contacting the receiving end of the gripper body.

10. The gripper of claim 8, wherein the receiving end is removable from the gripper body.

11. A system for packing a container, the system comprising:
a track; and
a gripper movable along the track,
wherein the gripper is configured to be releasably coupled to the container via vacuum to guide the container along a portion of the track and to maintain the container in a desired orientation.

12. The system of claim 11, further comprising an orienting module configured to orient the container in the desired orientation and to hand off the container to the gripper as the gripper moves along the track.

13. The system of claim 11, wherein the gripper comprises:
a vacuum source configured to generate the vacuum;
an actuator coupled to the vacuum source and configured to drive the vacuum source;
a suction body forming a first vacuum cavity in fluid communication with the vacuum source;
a suction cup coupled to the suction body and forming a second vacuum cavity; and
a valve coupled to the suction body and to the suction cup,
wherein the valve is configured to be selectively actuated between a closed position to restrict vacuum from the first vacuum cavity to the second vacuum cavity and an open position to supply the vacuum from the first vacuum cavity to the second vacuum cavity.

14. The system of claim 13, wherein the valve is configured to be actuated from the closed position to the open position in response to contact of the suction cup with the container.

15. The system of claim 13, further comprising a drive cam that extends along the track, wherein:
the vacuum source comprises a third vacuum cavity and a drive member situated within and movable relative to the third vacuum cavity;
the actuator comprises a cam follower coupled to the drive member; and
the cam follow is configured to engage the drive cam to selectively move the drive member within the third vacuum cavity as the gripper moves along the track.

16. A method for packing a container, the method comprising steps of:
orienting the container in a desired orientation;
transferring the container to a gripper as the gripper moves along a track;
coupling the container to the gripper via vacuum;
guiding the container along a portion of the track using the gripper;
maintaining the desired orientation of the container using the gripper; and
releasing the container from the gripper.

17. The method of claim 16, wherein the step of coupling the container to the gripper comprises:
generating the vacuum in a first vacuum cavity formed by a suction body of the gripper to generate the vacuum;
positioning a suction cup of the gripper in contact with the container; and
supplying the vacuum to a second vacuum cavity formed by the suction cup.

18. The method of claim 17, wherein the step of supplying the vacuum comprises actuating a valve coupled to the suction body and the suction cup from a closed position to an open position in response to contact of the suction cup with the container.

19. The method of claim 17, further comprising selectively controlling the vacuum as the gripper moves along the track.

20. The method of claim 18, wherein the step of selectively controlling the vacuum comprises:
moving a cam follower along a drive cam as the gripper moves along the track; and
selectively moving a drive member situated within a third vacuum cavity and coupled to the cam follower to generate the vacuum in the third vacuum cavity.
